(19) United States
(12) Patent Application Publication
(10) Pub. No.: US 2013/0124696 A1
(43) Pub. Date: May 16, 2013

(54) APPLICATION PRODUCTS WITH IN-APPLICATION SUBSEQUENT FEATURE ACCESS USING NETWORK-BASED DISTRIBUTION SYSTEM

(71) Applicant: APPLE INC., CUPERTINO, CA (US)

(72) Inventors: MICHAEL KUOHAO CHU, CUPERTINO, CA (US); SEAN B. KELLY, SAN FRANCISCO, CA (US); THOMAS ALSINA, MOUNTAIN VIEW, CA (US); MIHAILO DESPOTOVIC, LOS GATOS, CA (US)

(73) Assignee: APPLE INC., Cupertino, CA (US)

(21) Appl. No.: 13/735,939

(22) Filed: Jan. 7, 2013

Related U.S. Application Data
(63) Continuation-in-part of application No. 12/767,756, filed on Apr. 26, 2010.
Application No. 12/767,756 is a continuation-in-part of application No. 12/571,266, filed on Sep. 30, 2009.
(60) Provisional application No. 61/657,834, filed on Jun. 10, 2012.
(60) Provisional application No. 61/160,640, filed on Mar. 16, 2009.

(51) Int. Cl. H04L 29/08

(52) U.S. Cl. 709/219

(57) ABSTRACT

An improved system, device and method for accessing features of digital products with assistance from a content distribution system are disclosed. Third-party content can be submitted to and distributed by the content distribution system. In other words, the third-party content can be hosted (and distributed) by the content distribution system. A download interface can facilitate application programs operating on a client device to locally request and receive downloads from the content distribution system. Typically, a user of a client device would purchase an application program and then sometime later, using the application program, also purchase supplemental content for use with the application program. Once the supplemental content is purchased, it needs to be downloaded to the client device. Download policies are used to manage the download of supplemental content.

### CROSS-REFERENCE TO RELATED APPLICATIONS

This application claims priority to U.S. Provisional Patent Application No. 61/657,834, filed Jun. 10, 2012, entitled “APPLICATION PRODUCTS WITH IN-APPLICATION SUBSEQUENT FEATURE ACCESS USING NETWORK-BASED DISTRIBUTION SYSTEM”, which is hereby incorporated herein by reference.

This application is a continuation-in-part of U.S. patent application Ser. No. 12/767,756, filed Apr. 26, 2010, entitled “APPLICATION PRODUCTS WITH IN-APPLICATION SUBSEQUENT FEATURE ACCESS USING NETWORK-BASED DISTRIBUTION SYSTEM”, which is hereby incorporated herein by reference, which is a continuation-in-part of U.S. patent application Ser. No. 12/571,266, filed Sep. 30, 2009, entitled “APPLICATION PRODUCTS WITH IN-APPLICATION SUBSEQUENT FEATURE ACCESS USING NETWORK-BASED DISTRIBUTION SYSTEM”, which is hereby incorporated herein by reference, and which in turn claims priority to U.S. Provisional Patent Application No. 61/160,640, filed Mar. 16, 2009, entitled “APPLICATION PRODUCTS WITH IN-APPLICATION SUBSEQUENT FEATURE ACCESS USING NETWORK-BASED DISTRIBUTION SYSTEM”, which is hereby incorporated herein by reference.

### BACKGROUND OF THE INVENTION

1. Field of the Invention

The present invention relates to distribution of digital products and, more particularly, to network-based distribution of digital products.

2. Description of the Related Art

Today, online media stores, such as iTunes™ Media Store, allow customers (i.e., online users) to purchase or rent media items, such as music or videos, over the Internet. Often, at online media stores, numerous media items made available and are provided by various different content providers, such as music labels or movie companies. Software tools, such as iProducer™ and Label Connect™ available from Apple Inc. of Cupertino, Calif., can assist content providers with online submission of media content to the iTunes™ Media Store.

Software programs are also available to be purchased or licensed at retail stores as well as online stores. Conventionally, a software program is primarily purchased as a compact disc (CD) containing the software program. Alternatively, purchasers can often purchase and download a software program from an online retailer or a software provider's website. However, when an online retailer operates to sell software programs of various independent parties, there are difficulties in providing the digital program files and supporting information/files to the online retailers. This problem is exacerbated by a large number of small software providers that often desire to partner with the online retailer. As a result, online retailers that receive online submissions face substantial burdens and difficulties due to the wide range of variation with respect to the submissions.

Conventionally, after purchasing, download and installing a software program on a computing device, the software program is essentially a static product. Though some software programs can receive updates for fixing of errors or bugs or virus protections, these updates are freely provided and serve to maintain existing functionality. Unfortunately, some software providers have a need to facilitate follow-on purchases that augment the initial software programs. However, once a software program has be purchased online, download and installed, there is conventionally no convenient means for that software program to itself facilitate an in-application purchase of rights or privileges to additional functionality, components, content, etc. for the software program.

### SUMMARY

The invention relates to a system, device and method for accessing locked (secured) features of digital products with assistance from a product distribution site.

According to one aspect, a digital product can be submitted to a product distribution site for network-based distribution. The digital product can be initially provided such that it provides base functionality but contains one or more locked features that, if unlocked, can supplement the base functionality. If the digital product that has been submitted is approved, the digital product becomes available at the product distribution site such that users can search, browse and purchase the digital product. Once the digital product has been purchased, download and installed on a user's computing device, the user is able to utilized the digital product. However, since the digital product itself includes one or more locked features, the user is not able to utilize such features until a subsequent purchase is performed. Advantageously, the subsequent purchase can be invoked from the digital product. In doing so, the digital product interacts (directly or indirectly) with remote server (e.g., the product distribution site) to purchase access or usage for one or more of the locked features within the digital product. Once access or usage for the one or more locked features has been purchased, the one or more locked features within the digital product can be unlocked and thereafter utilized.

According to another aspect, a user of a client device may have previously acquired rights or permissions to access one or more supplemental features of one or more digital products (e.g., application programs). Typically, a user would purchase an application program and then sometime later also purchase supplemental features for use with the application program. In one implementation the supplemental features can be purchased using the application program with the assistance of a remotely located product distribution server. Sometime thereafter, in some cases, the user desires to make use of such previously acquired one or more supplemental features on another client device. For example, the user may wish or need to transfer from a former client device to a new client device. As another example, the user may wish to utilized (e.g., show) such previously acquired one or more supplemental features with another client device associated with the user, such as another client device within user's account.

In one embodiment, the digital products are computer program products (e.g., computer software programs). The product distribution site can also be referred to as an online product hosting site. Although the features of the digital products can vary depending on implementation, some examples of features include: modules, tools, characters, functionality, content, or data. Features can also be referred to as components.

According to another aspect, a client device can have a download interface that facilitates application programs operating on a client device to request and receive downloads from a remote data repository. A user of a client device may have previously acquired rights or permissions to access one or more supplemental content for use by one or more application programs. Typically, a user would purchase an application program and then sometime later, using the application program, also purchase supplemental content for use with the application program. In one implementation the supplemental content can be purchased using the application program itself. Once the supplemental content is purchased, it needs to be downloaded to the client device. Download policies are used to manage the download of supplemental content.

According to another aspect, third-party content can be submitted to and distributed by a content distribution system. In other words, the third-party content can be hosted (and distributed) by the content distribution system. The content distribution system can allow application programs to be supplemented by supplemental content that is associated with a previously obtained (e.g., purchased) application program.

The invention can be implemented in numerous ways, including as a method, system, device, apparatus (including computer readable medium and graphical user interface). Several embodiments of the invention are discussed below.

In one embodiment, a computer-implemented method for re-acquiring supplemental features for an application program can operate to receive a re-grant request from a requestor via a computing device for access to one or more supplemental features previously acquired from a network-based application distribution system. A set of one or more supplemental features previously acquired by the requestor from the network-based application distribution system can be determined. The computing device can then be permitted to utilize the one or more supplemental features in the set of one or more supplemental features.

In one embodiment, a computer readable medium including at least computer program code tangibly stored thereon for acquiring supplemental features for an application program can include computer program code for receiving a request from a requestor for access to one or more supplemental features previously acquired from a network-based application distribution system. The computer readable medium can also include computer program code for determining a set of one or more supplemental features previously acquired by the requestor from the network-based application distribution system, and computer program code for permitting the application program to utilize the one or more supplemental features in the set of one or more supplemental features determined to have been previously acquired by the requestor from the network-based application distribution system.

In one embodiment, a computer-implemented method for acquiring supplemental features for an application program can be achieved by at least the following operations. A re-grant request can be received from a requestor for access to one or more supplemental features that were previously acquired from a network-based application distribution system. The one or more supplemental features are for use with an application program. An acquisition history associated with the requestor can be accessed to identify one or more supplemental features previously acquired by the requestor from a network-based application distribution system. Re-grant eligibility for those of the one or more identified supplemental features can be determined based on at least one eligibility rule. Access can then be enabled to those of the one or more identified supplemental features determined to be re-grant eligible.

In one embodiment, a computer readable medium including at least computer program code tangibly stored thereon for acquiring supplemental features for an application program can include computer program code for receiving a request from a requestor via a computing device for access to at least one supplemental feature previously acquired for use with an application program. The computer readable medium can also include computer program code for determining whether the requestor previously acquired the application program with assistance of the network-base application distribution system, and computer program code for determining whether the requestor previously acquired the at least one supplemental feature with assistance of the network-base application distribution system. Still further, the computer program code can include computer program code for permitting the application program to access the at least one supplemental feature, provided that (i) it is determined that the requestor previously acquired the application program with the assistance of the network-based application distribution system, and (ii) it is determined that the requestor previously acquired the at least one supplemental feature with assistance of the network-base application distribution system.

In one embodiment, a computer-implemented method for acquiring supplemental features for an application program can be achieved by at least the following operations. The method can receive at least one download policy from a remote server to a local client device via at least one network, and store the at least one download policy at the local client device. The method can also manage downloads for at least one application program operable on the client device based on the at least one download policy.

In one embodiment, a non-transitory computer readable medium including at least computer program code for managing download of electronic content to client devices can, for example, include computer program code for receiving at least one download policy from a remote server to a local client device via at least one network, and computer program code for storing the at least one download policy at the local client device. The non-transitory computer readable medium can further include computer program code for managing downloads for at least one application program operable on the client device based on the at least one download policy.

In one embodiment, a mobile computing device can, for example, include at least one application program able to operate in the mobile computing device. The mobile computing device can further include a commerce server resident on the mobile computing device, and a download manager. The commerce server can be configured to interact with a remote server to facilitate access to supplemental content for use with the at least one application program. The download manager resident on the mobile computing device can be configured to manage download of the supplemental content over a network to the mobile computing device, provided that the remote server permits access to the supplemental content.

In one embodiment, a portable client computing device can include an operating system, and a data storage device. The operating system can include a commerce server and a download manager. The commerce server can be configured to communicate over a network with a remote server to acquire or activate application programs and supplemental features therefore. The download manager can be configured to manage download of at least the supplemental features. The operating system can also include a data storage device configured to store an application program and also storing at least one supplemental feature for use by the application program. The application program can be configured to communicate with the commerce server to: (i) acquire rights to access the at least one supplemental feature, and (ii) render the at least one supplemental feature accessible by the application program if the rights to acquire the at least one supplemental feature have been acquired. The application program can be configured to communicate with the download manager to receive the at least one supplemental feature and thereafter access the at least one supplemental feature.

As a method for accessing supplemental features for an application program, the method operates on a computing device, and the method can execute an application program on the computing device. The application program can have been previously acquired from a remote network-based distribution system. The method also can determine that a user of the application program desires to acquire usage of at least one supplemental feature that is available from the remote network-based distribution system. The method also can request that the remote network-based distribution system approve access to the at least one supplemental feature, and receive download information from the remote network-based application distribution system that the at least one supplemental feature is approved for access. Thereafter, the method can further download the at least one supplemental feature to the computing device, thereby permitting the application program to utilize the at least one supplemental feature.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like elements, and in which:

FIG. 1 is a block diagram of a product submission and distribution system according to one embodiment of the invention.

FIG. 2 is a block diagram of a client, or client device, according to one embodiment of the invention.

FIGS. 3A-3C are diagrams illustrating accessing supplemental features according to one embodiment of the invention.

FIG. 4 is a flow diagram of a digital product submission process according to one embodiment of the invention.

FIG. 5 is a flow diagram of a supplemental feature client process according to one embodiment of the invention.

FIGS. 6A and 6B are flow diagrams of a supplemental feature client process according to one embodiment of the invention.

FIG. 7 is a flow diagram of a supplemental feature server process according to one embodiment of the invention.

FIG. 8 is a block diagram of a product distribution site according to one embodiment.

FIG. 9 is a flow diagram of a feature re-acquisition process according to one embodiment.

FIG. 10 is a flow diagram of previously acquired features process according to one embodiment.

FIG. 11 is a flow diagram of a supplemental feature access process according to one embodiment.

FIG. 12 is a re-grant process according to one embodiment.

FIG. 13 illustrates a flow diagram of a supplemental feature access process according to one embodiment.

FIG. 14 is a block diagram of a client, or client device, according to another embodiment.

FIG. 15 is a flow diagram of a download management process according to one embodiment.

FIGS. 16A and 16B illustrate a download management process according to another embodiment.

FIG. 17A is a block diagram of a network-based content distribution system according to one embodiment.

FIG. 17B is a block diagram of the network-based content distribution system shown in FIG. 17A when supplemental content acquired and downloaded.

### DETAILED DESCRIPTION OF CERTAIN EMBODIMENTS

The invention relates to a system, device and method for accessing locked (secured) features of digital products with assistance from a product distribution site.

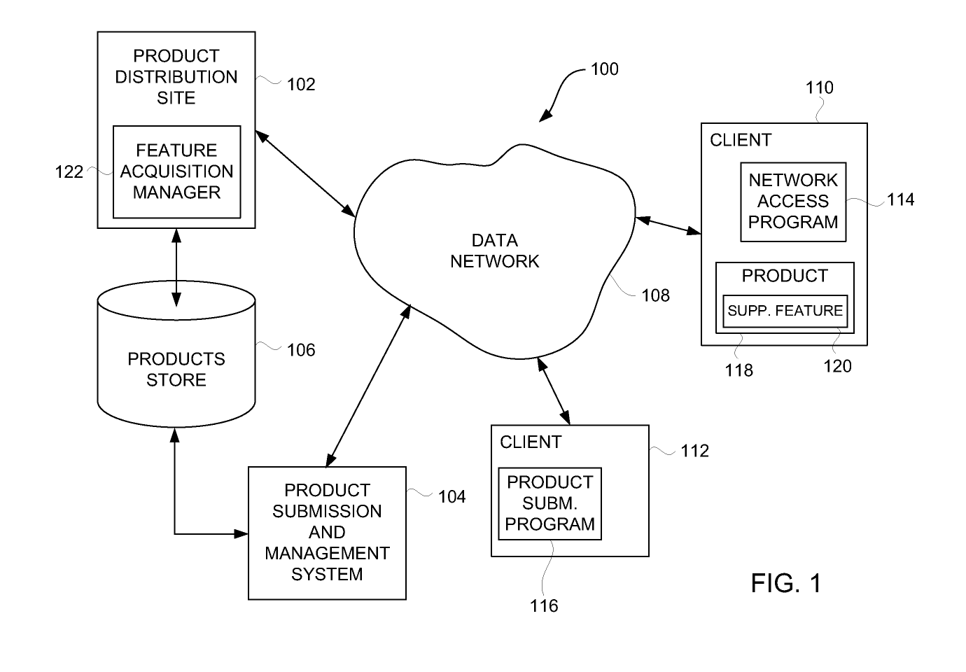

Embodiments of various aspects of the invention are discussed below with reference to FIGS. 1-17B. However, those skilled in the art will readily appreciate that the detailed description given herein with respect to these figures is for explanatory purposes as the invention extends beyond these limited embodiments.

According to one aspect, a digital product can be submitted to a product distribution site for network-based distribution. The digital product can be initially provided such that it provides base functionality but contains one or more locked features that, if unlocked, can supplement the base functionality. If the digital product that has been submitted is approved, the digital product becomes available at the product distribution site such that users can search, browse and purchase the digital product. Once the digital product has been purchased, download and installed on a user's computing device, the user is able to utilized the digital product. However, since the digital product itself includes one or more locked features, the user is not able to utilize such features until a subsequent purchase is performed. Advantageously, the subsequent purchase can be invoked from the digital product. In doing so, the digital product interacts (directly or indirectly) with a remote server (e.g., the product distribution site) to purchase access or usage for one or more of the locked features within the digital product. Once access or usage for the one or more locked features has been purchased, the one or more locked features within the digital product can be unlocked and thereafter utilized.

In one embodiment, the digital products are computer program products (e.g., computer software programs). The product distribution site can also be referred to as an online product hosting site. Although the features of the digital products can vary depending on implementation, some examples of features include: modules, tools, characters, functionality, content, or data. Features can also be referred to as components.

FIG. 1 is a block diagram of a product submission and distribution system 100 according to one embodiment of the invention. The product submission and distribution system 100 includes a product distribution site 102. The product distribution site 102 provides an online access point for distribution of various digital products. For example, the product distribution site 102 can be referred to as an online store. A product submission and management system 104 operates to receive submissions of digital products from various digital product submitters. The product submission and management system 104 can process submission of digital products and authorize distribution of approved digital products. The digital products can be stored in a products store 106. In one embodiment, the products store 106 includes a mass data store and/or one or more databases. The products store 106 provides mass storage of the numerous digital products that are available for distribution (e.g., purchase). For example, digital products that have been purchased can be accessed from the products store 106 over a data network 108 by way of the product distribution site 102. Examples of digital products are computer program products such as applications (or application programs), animations, or presentations.

The product submission and distribution system 100 also includes a first client 110 and a second client 112. Typically, the product submission and distribution system 100 would include a plurality of different clients 110, 112. The first client 110 includes a network access program 114. The second client 112 includes a product submission program 116. Some clients can also include both the network access program 114 and the product submission program 116. The network access program 114 is an application program (e.g., software application) that operates on the first client 110, which is a computing device. One example of a suitable network access program is a network browser (e.g., Microsoft Explorer or Safari). Another example of a suitable network access program is iTunes™ offered by Apple Inc. The first client 110 can be coupled to the product distribution site 102 through the data network 108. Hence, any of the first clients 110 can interact with the product distribution site 102 to review, purchase and/or manage digital products.

The product submission program 116 is also an application program (e.g., software application) that operates on the second client 112, which is a computing device. The product submission program 116 is used to submit digital products to the product submission and management system 104 for eventual distribution by the media distribution site 102. Although the network access program 114 and the product submission program 116 are shown in FIG. 1 as separate programs, it should be understood that such programs can be integrated into a single program or reside on the same client machine.

In the product submission and distribution system 100 shown in FIG. 1, the digital products are submitted to the product submission and management system 104 by way of the product submission program 116. The digital products that have been submitted (e.g., via the second client 112) are processed and then, if accepted, stored in the products store 106 for distribution. Thereafter, the stored digital products are available to be purchased from the product distribution site 102.

The product submission and distribution system 100 allows a user of the client 110 to utilize the network access program 114 to browse, search or sort through a plurality of digital products that can be purchased from the product distribution site 102. The network access program 114 may also allow the user to preview or demo some or all of a digital product. In the event that the user of the network access program 114 desires to purchase a particular digital product, the user (via the network access program 114) and the product distribution site 102 can engage in an online commerce transaction in which the user pays for access rights to the particular digital product. In one embodiment, a credit card associated with the user is credited for a purchase or rental amount of the particular digital product.

Upon purchasing a particular digital product, the product distribution site 102 permits the digital data for the particular digital product to be retrieved from the products store 106 and then delivered (e.g., downloaded) from the product distribution site 102 to the requesting client 110 through the data network 108. In this regard, the product distribution site 102 or some other delivery server (not shown) obtains the digital data corresponding to the particular digital product from the products store 106 and downloads such digital data through the data network 108 to the client 110. The downloaded digital data can then be stored on the client 110. In one embodiment, the downloaded digital data is encrypted as received at the client 110 but is decrypted and then perhaps re-encrypted before being persistently stored on the client 110. Thereafter, the client 110 can utilize (e.g., execute) the digital data of the digital product at the client 110.

The submission and purchase of the digital products can be achieved over the data network 108. In other words, the submission and purchase of the digital products can be achieved online. The purchase of media items online can also be referred to as electronic commerce (e-commerce). In one embodiment, the data network 108 makes use of at least a portion of the Internet. In one embodiment, the connections through the data network 108 between the product distribution site 102 and the clients 110, 112 can be through secure connections, such as Secure Sockets Layer (SSL). The clients 110, 112 can vary with application but generally are computing devices that have memory storage. Often, the clients 110, 112 are personal computers or other computing devices that are capable of storing and presenting media to their users. In one embodiment, one or more of the clients can be portable computing devices (e.g., laptop or network computers) or handheld computing devices (e.g., PDAs, smart phones, multi-function electronic devices, or media players).

The digital products can include one or more supplemental features. The supplemental features can serve to supplement or augment corresponding digital products. As shown in FIG. 1, a digital product 118 acquired and downloaded from the product distribution site 102 via the data network 108 can be stored on the client 110. In one embodiment, the digital product 118 can include a supplemental feature 120. However, when the digital product 118 is initially acquired, the supplemental feature 120 is inactive or locked such that it is not usable by the digital product 118. However, during operation of the digital product 118 on the client 110, the digital product 118 can initiate acquisition of usage of the supplemental feature 120. In such case, the digital product 118 (itself or with assistance of an operating system) can communicate with a feature acquisition manager 122 of the product distribution site 102. Typically, the digital product 118 was previously acquired from the product distribution site 102. The feature acquisition manager 122 manages processing of incoming requests for access to supplemental features. For example, the feature acquisition manager 122 receives the incoming requests for access to supplemental features, determines whether the request is valid and permitted to be processed, processes payment, if any, for such access, and sends an authorization response to the requesting client device 110. Upon receiving the authorization response, the digital product 118 can render the supplemental feature 120 accessible (i.e., unlocked). In such an embodiment, the supplemental feature is provided with the digital product 118 as initially downloaded to the client 110, and thereafter only an authorization need to be delivered to the client 110 to render the supplemental feature 120 active. However, in an alternative embodiment, the supplemental feature 120 could be delivered to the client 110 only after authorized (and thus provided separately from the delivery of the digital product 118).

Although the product distribution site 102, the product submission and management system 104 and the products store 106 are shown in FIG. 1 as being separate components, it should be understood that any of these components can be combined into one or more apparatus. For example, the product submission and management system 104 can be incorporated into the product distribution site 102. As another example, the products store 106 can be incorporated into the product distribution site 102 or the product submission and management system 104.

To facilitate communication with the product distribution site (e.g., the feature acquisition manager 122) by the client 110 with respect to acquiring usage of the supplemental feature 120 of the application program 118, the product distribution site 102 can support an Application Programming Interface (API). For example, the APIs for the product distribution site 102 might, in once embodiment, include the following APIs shown in Appendix A of U.S. patent application Ser. No. 12/767,756, which is incorporated herein by reference.

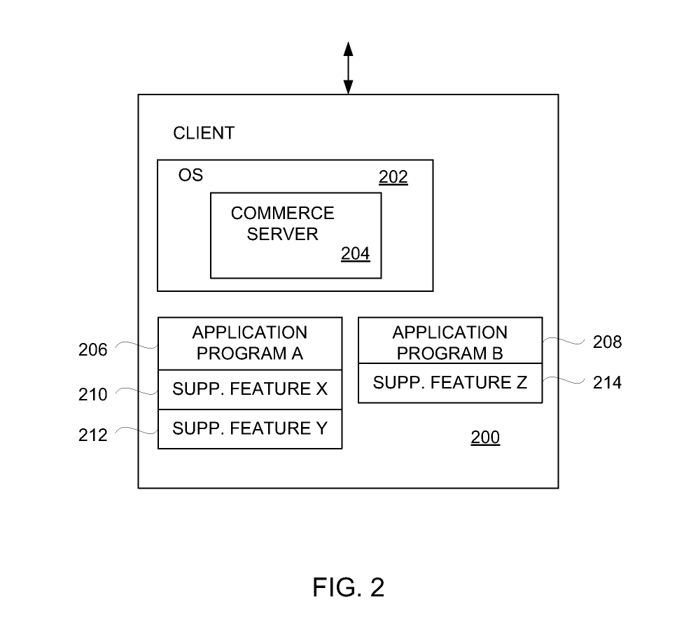

FIG. 2 is a block diagram of a client 200, or client device, according to one embodiment of the invention. The client 200 can, for example, be suitable for use as the client 110 illustrated in FIG. 1.

The client 200 includes an operating system (OS) 202 that operates on the client 200 to provide basic computing services to application programs that may execute on the client 200. In addition, the operating system 202 includes a commerce server 204. The commerce server 204 is utilized by application programs operating on the client 200 to perform commerce operations with respect to a remote server, such as a remote digital product distribution server. For example, the remote server can pertain to the product distribution server 102 illustrated in FIG. 1.

The client 200 can also includes one or more application programs that are installed on the client 200 and which can be executed by the client 200. Typically, these application where acquired and download from a remote server (e.g., product distribution server 102) to the client 200. The applications resident and installed on the client 200 are represented by application program A 206 and application program B 208. As illustrated in FIG. 2, the application program A 206 includes a supplemental feature X 210 and a supplemental feature Y 212. Typically, as the application program A 206 is initially acquired from a remote server, the supplemental features 210 and 212 are present but “locked” and thus are not currently usable. Similarly, the application program B 208 as acquired includes the supplemental feature Z 214 which is initially “locked”. Additionally, the application program A 206 and the application program B 208 can interact with the remote server (e.g., remote digital product distribution server) by way of the commerce server 204 so as to have the desired one or more of the supplemental features 210, 212 and 214 “unlocked”. Once a supplemental feature becomes “unlocked”, the associated application program can thereafter utilize the supplemental feature.

To facilitate communication between the application programs 206, 208 and the commerce server 204, the commerce server 204 can support an Application Programming Interface (API). For example, the APIs for the commerce server 204 might, in one embodiment, include the following APIs shown in Appendix B of U.S. patent application Ser. No. 12/767,756, which is incorporated herein by reference.

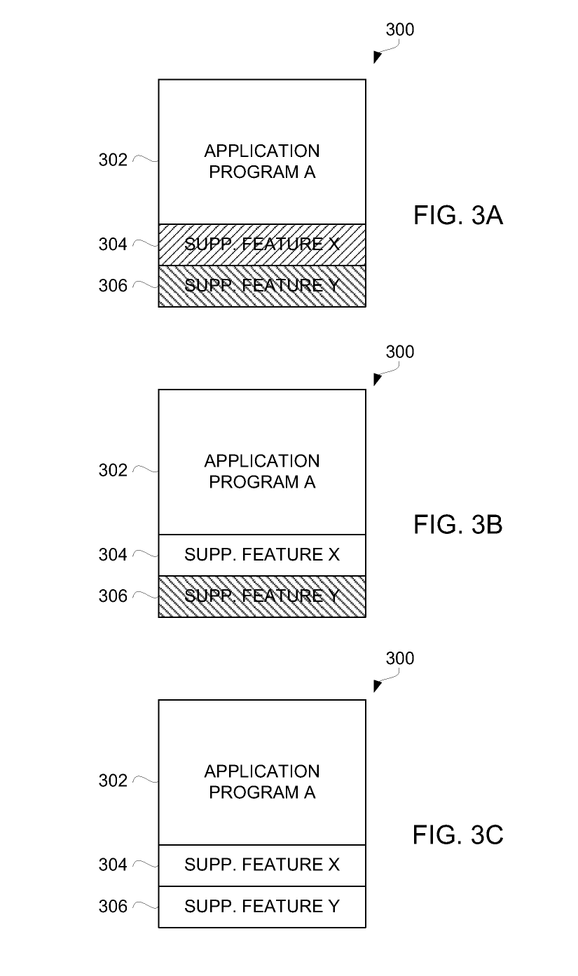

FIGS. 3A-3C are diagrams illustrating accessing supplemental features according to one embodiment of the invention. FIG. 3A illustrates an exemplary digital product 300 according to one embodiment. The exemplary digital product 300 can be acquired from a remote server, such as the product distribution site 102 illustrated in FIG. 1. The exemplary digital product 300 includes not only an application program 302 but also a supplemental feature X 304 and a supplemental feature Y 306. As shown in FIG. 3A, the supplemental feature X 304 and the supplemental feature Y 306 are both in the “locked” state. As discussed further herein, when authorized, the supplemental features of an application program can be unlocked. In general, the supplemental features can be unlocked individually and in some cases a quantity (greater than one) of like features can be made available. In FIG. 3B, the supplemental feature X 304 of the exemplary digital product 300 has been “unlocked” such that it can be used in conjunction with the application program A 302. However, the supplemental feature Y 306 remains “locked” in FIG. 3B. In FIG. 3C, the supplemental feature X 304 and the supplemental feature Y 306 of the exemplary digital product 300 have both been “unlocked” such that they can be used in conjunction with the application program A 302.

As noted above, the supplemental features (or supplemental components) of application programs (or digital products) can vary depending on implementation. The supplemental features can pertain to: modules, tools, characters, functionality, content, or data. For a game-based application program, the supplemental features can be: new weapons, new characters, extended lives, additional game levels, etc. For productivity applications, the supplemental feature can be: additional modules (e.g., yearly module, geographic module, content-based module, etc.), additional or enhanced functions (wireless communications, printing, storage, etc.), etc. For informational applications, the supplemental feature can be: additional content or data, additional learning or information modules, etc.

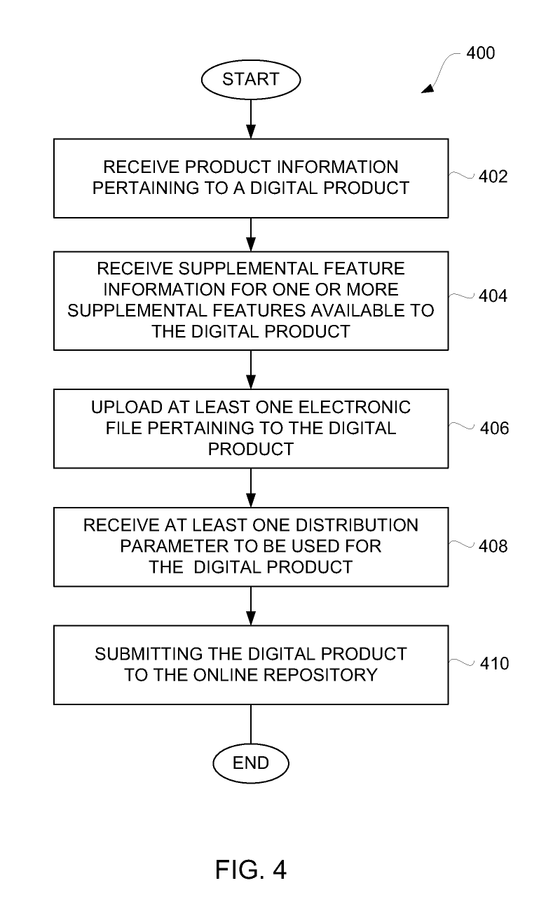

FIG. 4 is a flow diagram of a digital product submission process 400 according to one embodiment of the invention. The digital product submission process 400 can, for example, be performed by a client device, such as the client 112, or a server device, such as the product submission and management system 104.

The digital product submission process 400 can receive 402 product information pertaining to a digital product. The product information can vary depending upon the type of digital product being submitted. In one implementation, one type of digital product that can be submitted to an online repository by the digital product submission process 400 is a digital program product, such as a computer program product. Examples of product information for a computer program product can include one or more of: a product name, a supported device type indication, genre indication, version number, product identifier, support information, and license agreement information. In addition, when the digital program product incorporates one or more supplemental features, the digital product submission process 400 can also receive 404 supplemental information for the one or more supplemental features.

Next, a least one electronic file pertaining to a digital product can be uploaded 406. The digital product can have one or more electronic files associated therewith. For example, the digital product may include a binary file, a support or help file, and/or one more exemplary screen illustrations.

In addition, a least one distribution parameter to be used with the digital product can be received 408. A distribution parameter is a parameter that can be utilized to control or influence the manner in which the digital product is able to be distributed. One example of a distribution parameter is a pricing parameter. As an example, a pricing parameter can specify a price or a price tier to be associated with the digital product. Other distribution parameters can pertain to digital storefronts from which the digital product is to be distributed from. Still further, distribution parameters could also pertain to preview eligibility, license categories (types), etc.

Thereafter, the digital product can be submitted 410 to the online repository. The online repository can, for example, correspond to the product submission and management system 104. The online repository can receive the one or more electronic files, the associated product information, the supplemental feature information, and the one or more distribution parameters. The online repository can then operate to permit distribution of the digital product, as contained in the one or more electronic files, from a product distribution site (e.g., an online store) in accordance with the product information and the one or more distribution parameters. The online repository can also then operate to facilitate subsequent access to the one or more supplemental features of the digital product. After the submission 410 of the digital product to the online repository, the digital product submission process 400 can end.

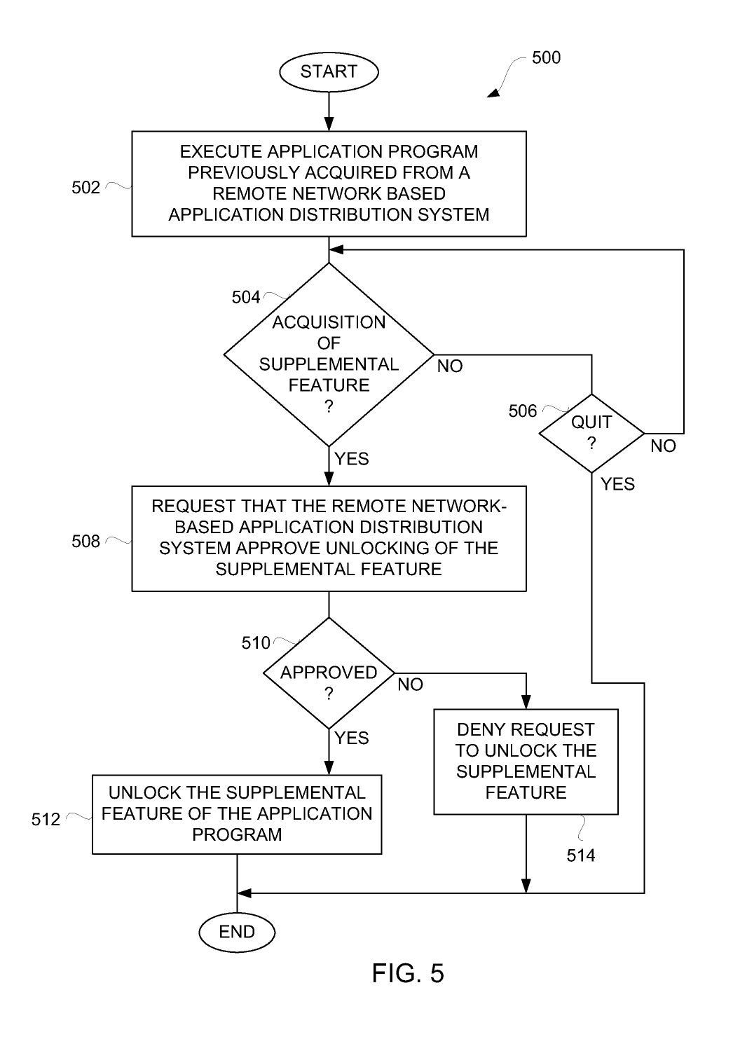

FIG. 5 is a flow diagram of a supplemental feature client process 500 according to one embodiment of the invention. The supplemental feature client process 500 can, for example, be performed on a client (i.e., client device), such as the client 110 illustrated in FIG. 1.

The supplemental feature client process 500 can execute 502 an application program previously acquired from a remote network-based application distribution system. For example, the remote network-based application description system can, for example, pertain to the product submission and distribution system 100 illustrated in FIG. 1. Here, an application program that was previously acquired from the remote network-based application distribution system is executed 502 at the client. At some point during execution, a decision 504 can be presented at the client. The decision 504 determines whether or not acquisition of a supplemental feature is to be performed. In one embodiment, the decision 504 can be determined based on user input indicating whether or not a user of the client desires to acquire the supplemental feature for the application program. For example, during execution of the application program, the application program can present a supplemental feature offer to the user, and the user can respond to the offer, thereby indicating whether or not the supplemental feature is desired by the user.

In any case, when the decision 504 determines that acquisition of a supplemental feature is not requested, a decision 506 can determine whether the application program should quit (i.e., end). When the decision 506 determines that the application program should not quit, then the application program continues and the supplemental feature client process 500 returns to repeat the decision 504. Alternatively, when the decision 506 determines that the application program should quit, then the supplemental feature client process 500 can end.

On the other hand, when the decision 504 determines that acquisition of a supplemental feature is requested, a request 508 can be made to the remote network-based application distribution system. The request 508 can be a request that the remote network-based application distribution system approve unlocking of the supplemental feature. A decision 510 can then determine whether the remote network-based application distribution system has approved the unlocking of the supplemental feature. When the decision 510 determines that the remote network-based application distribution system has approved the unlocking of the supplemental feature, the supplemental feature of the application program can be unlocked 512. Here, in one environment, the remote network-based application distribution system can inform the client that the supplemental feature is approved to be unlocked, and then the application program can operate to unlock the supplemental feature. Alternatively, when the decision 510 determines that the remote network-based application distribution system has not approved (i.e., denied) the unlocking of the supplemental feature, the request to unlock the supplemental feature is denied 514. Here, by informing the client that the supplemental feature is not approved to be unlocked, the application program does not operate to unlock the supplemental feature, whereby the supplemental feature remains locked. Following the block 512 or the block 514, the supplemental feature client process 500 can end.

In one embodiment, a receipt can be used by the remote network-based application distribution system to determine whether to approve unlocking of a supplemental feature. The client can receive a receipt when a digital product is acquired, e.g., through purchase or otherwise. Hence, the receipt can be received and archived at the client. Subsequently, if there is a need to determine whether the client previously properly acquired the digital product, the archived digital receipt can be used. The receipt can be cryptographically signed to preserve its integrity. The receipt is an electronic document, such as a markup language document, that can specify at least a digital product identifier (e.g., supplemental feature identifier), an application identifier, a transaction date, a transaction identifier, subscription identifier and an expiration indication. The receipt can include a quantity in the even that the receipt is for more than one of the supplemental features.

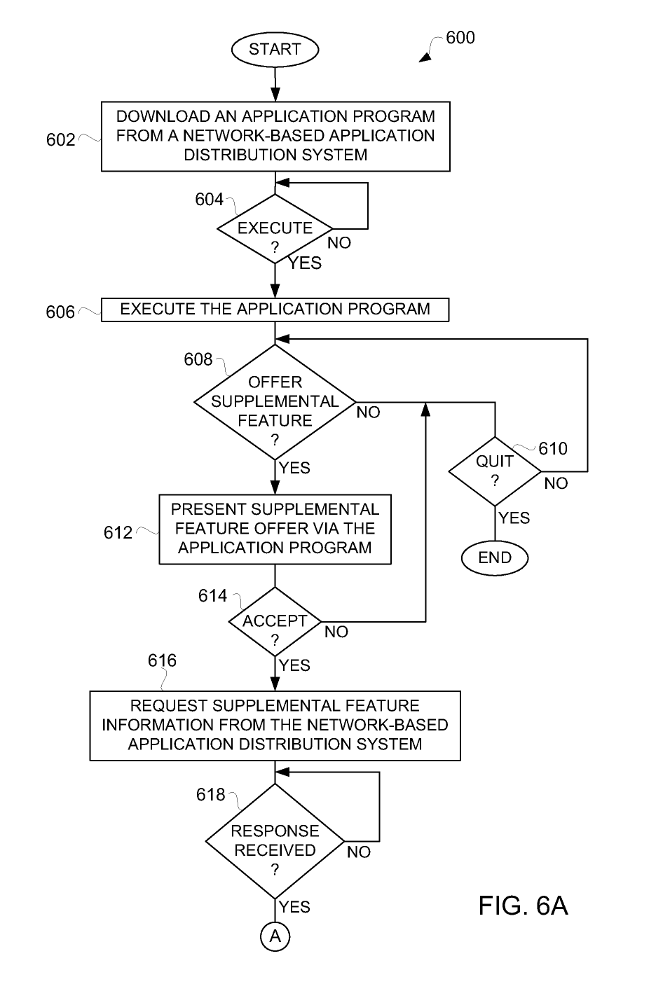

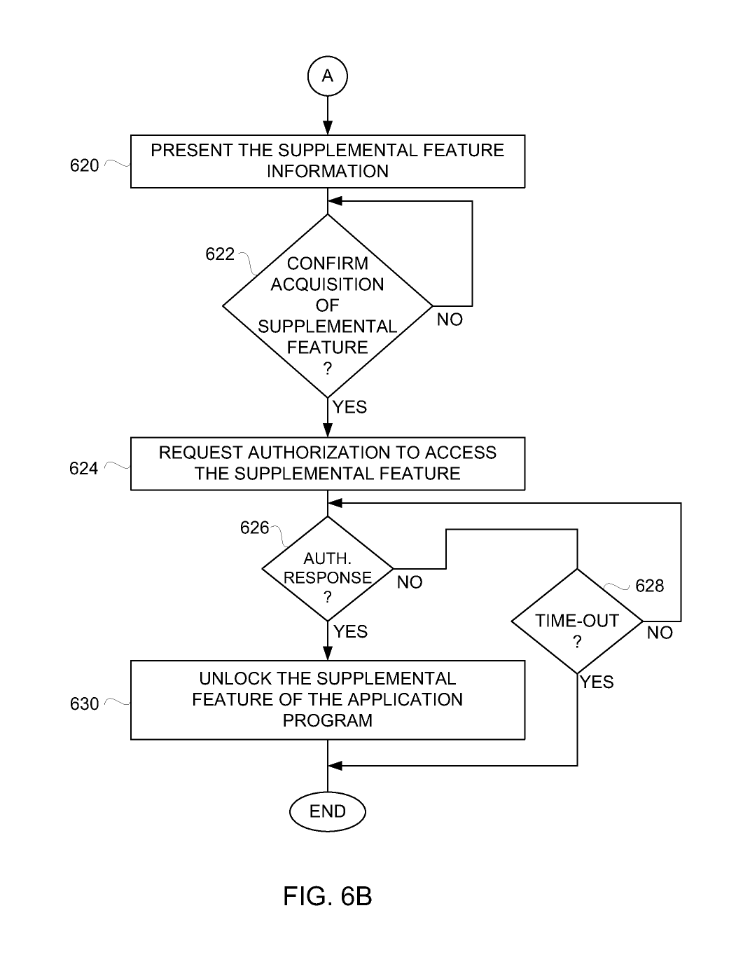

FIGS. 6A and 6B are flow diagrams of a supplemental feature client process 600 according to one embodiment of the invention. The supplemental feature client process 600 can, for example, be performed by a client (client device), such as the client 110 illustrated in FIG. 1.

The supplemental feature client process 600 can begin by download 602 of an application program from a network-based application distribution system. For example, a user of the client can interact with the network-based application distribution system to identify, purchase and download the application program. Once downloaded, the application program can be installed on the client. Thereafter, a decision 604 can determine whether the application program is to be executed. When the decision 604 determines that the application program is not the executed, the supplemental feature client process 600 effectively waits until the application program is executed. Once the decision 604 determines that the application program is to be executed, the application program is executed 606.

Next, a decision 608 can determine whether a supplemental feature is to be offered at the client. When the decision 608 determines that a supplemental feature is not the offered, a decision 610 can determine whether the supplemental feature client process 600 should quit (end). When the decision 610 determines that the supplemental feature client process 600 should end, then the supplemental feature client process 600 can end without rendering a supplemental feature available. Alternatively, when the decision 610 determines that the supplemental feature client process 600 should not end, the supplemental feature client process 600 can return to repeat the decision 608.

On the other hand, when the decision 608 determines that a supplemental feature is to be offered, a supplemental feature offer can be presented 612. Here, the supplemental feature offer being presented 612 can be viewed or heard by the user of the client operating the application program. In one implementation, the supplemental feature offer is presented 612 by the application program being executed on the client. A decision 614 can then determine whether the user accepts the supplemental feature offer. When the decision 614 determines that the user has not accepted the supplemental feature offer, the supplemental feature client process 600 can return to repeat the decision 610 whereby the supplemental feature client process 600 can continue or quit.

Alternatively, when the decision 614 determines that the user has accepted the supplemental feature offer, supplemental feature information can be requested 616 from the network-based application distribution system. A decision 618 determines whether a response has been received to the request for the supplemental feature information. When the decision 618 determines that a response is not yet been received, the supplemental feature client process 600 can await such a response. On the other hand, once the decision 618 determines that a response to the request for the supplemental feature information has been received, the supplemental feature information can then be presented 620. The supplemental feature information is presented 620 to provide the user of the application program operating on the client with information about the supplemental feature being offered. For example, the supplemental feature information can be displayed by the client, such as the application program or by an operating system.

Next, a decision 622 can determine whether the user has confirmed acquisition of the supplemental feature. According to one implementation, apart from the application program, the operating system can require that the user confirm that they desire to acquire the supplemental feature. This decision 622 serves to manage the acquisition of supplemental features in a controlled way so that application programs do not carelessly or inappropriately acquire supplemental features for users. When the decision 622 determines that the acquisition of the supplemental feature has not yet been confirmed, the supplemental feature client process 600 can await such a confirmation. In the event that the confirmation does not occur within a predetermined period of time, the decision 622 could alternatively cause the supplemental feature client process 600 to end.

Alternatively, when the decision 622 determines that the acquisition of the supplemental feature has been confirmed by the user, authorization to access the supplemental feature can be requested 624. Here, the request for authorization to access the supplemental feature can, for example, be made to the networked-based application distribution system. A decision 626 can then determine whether authorization to access the supplemental feature has been received. The authorization can be provided as or within an authorization response. The authorization response, if provided, is received by the client. Hence, the decision 626 determines whether the authorization response has been received. When the decision 626 determines that the authorization response has not been received, a decision 628 can determine whether a time-out has occurred. When the decision 628 determines that a time-out has occurred, the supplemental feature client process 600 can end. On the other hand, when the decision 628 determines that a time-out has not occurred, the supplemental feature client process 600 can return to repeat the decision 626 to await the reception of the authorization response. Once the decision 626 determines that the authorization response has been received, the supplemental feature of the application program can be unlocked 630. Typically, the application program itself can act to unlock the supplemental feature if the authorization response is provided to the client. Following the block 630, the supplemental feature client process 600 can end.

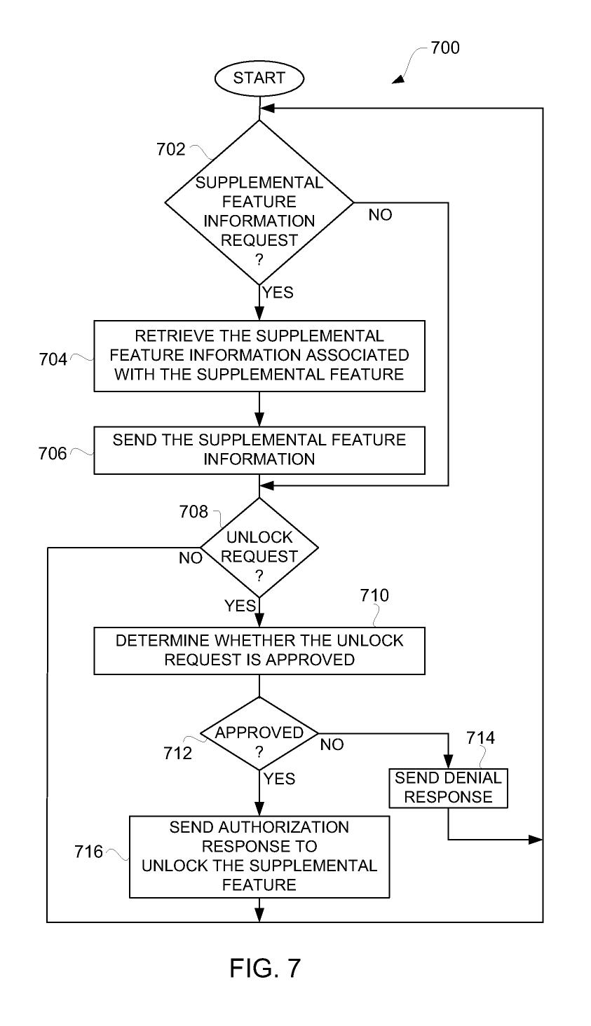

FIG. 7 is a flow diagram of a supplemental feature server process 700 according to one embodiment of the invention. The supplemental feature server process 700 is, for example, performed by a server (server device) such as the product distribution site 102 illustrated in FIG. 1.

The supplemental feature server process 700 can began with a decision 702. The decision 702 can determine whether a supplemental feature information request has been received. Typically, the supplemental feature information request can be received from a client. As an example, the supplemental feature information request can be initiated by block 616 of the supplemental feature client process 600 illustrated in FIGS. 6A and 6B.

When the decision 702 determines that a supplemental feature information request has been received, the supplemental feature information associated with the supplemental feature can be retrieved at 704. For example, the server has access to data storage that can store the supplemental feature information for a plurality of different supplemental features. As a particular example, the supplemental feature information can be part of the product information stored in the products storage 106, which may be a database. The supplemental feature information that has been retrieved 704 can then be sent 706. Typically, the supplemental feature information is sent 706 to the client that initiated the supplemental feature information request. Alternatively, when the decision 702 determines that a supplemental feature information request has not been received, the blocks 704 and 706 can be bypassed.

Following the block 706, or its being bypassed, the supplemental feature server process 700 can perform processing associated with unlocking a supplemental feature. Specifically, a decision 708 can determine whether an unlock request has been received. Typically, the unlock request can be received from the client. As an example, the unlock request (which is also an authorization request) can be initiated by block 624 of the supplemental feature client process 600 illustrated in FIGS. 6A and 6B.

When the decision 708 determines that an unlock request has been received, the supplemental features server process 700 can determine 710 whether the unlock request is to be approved. In one implementation, the approval can require that one or more requirement be met. The requirements can vary with implementation be can include one or more of payment for the supplemental feature, prior purchase of the application program, existence of user account, etc. When the decision 712 determines that the unlock request is not approved, the supplemental feature server process 700 can send 714 a denial response to the client that made the unlock request. The denial response may indicate a reason for the denial. Alternatively, when the decision 712 determines that the unlock request is approved, an authorization response to unlock the supplemental feature can be sent 716 to the client providing the unlock request. The authorization response can include an authorization code or codes can that can be utilized to unlock the particular supplemental feature for which the unlock has been requested. In one implementation, the authorization response is sent 716 to the application program operating on the client, and the application program can then act to unlock the supplemental feature (e.g., block 630 of the supplemental feature client process 600 illustrated in FIGS. 6A and 6B).

On the other hand, when the decision 708 determines that an unlock request has not been received, the block 710-716 can be bypassed. Following the blocks 714 or 716 (or the bypass of such blocks), the supplemental features server process 700 can return to repeat the decision 702.

According to another aspect, a user of a client device may have previously acquired rights or permissions to access one or more supplemental features of one or more digital products (e.g., application programs). Typically, a user would purchase an application program and then sometime later also purchase supplemental features for use with the application program. In one implementation the supplemental features can be purchased using the application program with the assistance of a remotely located product distribution server. Sometime thereafter, in some cases, the user desires to make use of such previously acquired one or more supplemental features on another client device. For example, the user may wish or need to transfer from a former client device to a new client device. As another example, the user may wish to utilized (e.g., share) such previously acquired one or more supplemental features with another client device associated with the user, such as another client device within user's account.

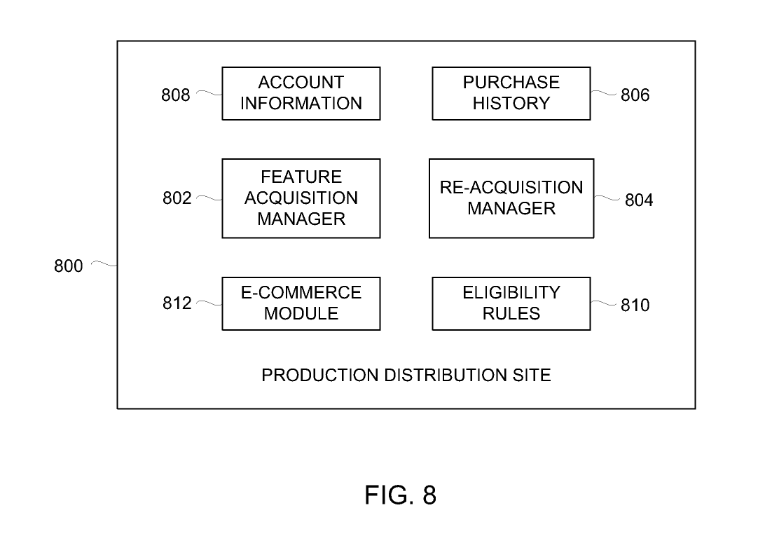

FIG. 8 is a block diagram of a product distribution site 800 according to one embodiment. The product distribution site 800 is coupled to a data network and can operate as a remote server for numerous client devices. That is, the product distribution site 800 can facilitate providing digital products, such as digital media items, to client devices associated with users that have been authorized to receive such digital products. The product distribution site 800 can, for example, represent one embodiment of the product distribution site 102 illustrated in FIG. 1.

The product distribution site 800 can include a feature acquisition manager 802. The feature acquisition manager 802 can, via a network, interact with an application program operating on a client device. The feature acquisition manager 802 can thus control access to one of more features associated with the application program. As an example, the application program can offer a user of the client device the ability to access (e.g., purchase) one or more features associated with the application program. These features can be referred to as supplemental features since they serve to supplement the basic operation of the application program, and can thus be used to enhance operation of the application program on the client device. When the user requests to access one or more of the features, the feature acquisition manager 802 can manage the payment processing (if any) as well as subsequent authorization for the user to access to the one or more features for which payment has been made.

In addition, after a supplemental feature or an application program has been authorized and then thereafter made available to the application program being used by the user of the client device, the user may have a need to subsequently again obtain the same supplemental feature for the same application program. For example, the supplemental features originally obtained may have been inadvertently deleted at the client device, the user may have obtained a replacement client device, or the like.

The user of the client device may visit the product distribution site 800 and acquire access to one or more supplemental features as if they never previously acquired the one or more supplemental features (i.e., with payment for such access). However, a more robust and user-friendly system can offer the user to the ability to re-acquire the one or more supplemental features (e.g., provided that the user originally previously acquired the one or more supplemental features). Hence, the product distribution site 800 can further include a re-acquisition manager 804.

The re-acquisition manager 804 can operate to enable the product distribution site 800 to support users of client devices with re-acquisition of one or more supplemental features that they previously acquired. In doing so, the product distribution site 800 can store purchase history information 806, account information 808, and eligibility rules 810. The purchase history 806 can provide a database of purchase information regarding purchases of any supplemental features previously made by users. The account information 808 can store information regarding various users in user accounts. In one embodiment, a user account can associate a user to a client device. The purchase history 806 can also be provided on a per account, per user and/or per client device basis. Still further, the eligibility rules 810 can serve to limit the extent to which users are able to re-acquire supplemental features. Since, in one embodiment, re-acquisition of supplemental features is intended to two benefit those users that previously acquired the supplemental features in the normal fashion (often with the payment of a purchase price), the eligibility rules can serve to restrict re-acquisition to certain situations. As one example, the eligibility rules might limit re-acquisition to supplemental features that (i) are non-consumable, (ii) are for an application program (for which the supplemental features are associated) that was previously acquired (e.g., purchased), and (iii) are supplemental features that were previously acquired (e.g., purchased). The eligibility rules can require that the previous acquisitions be by the same user or device. Alternatively, the eligibility rules can require that the previous acquisitions by any device or user associated with a user account or set of related user accounts. In the case of user accounts, the eligibility rules can require that the previous acquisitions be from one or more client devices that are associated (e.g., linked) with a user account (e.g., the client device is an authorized computer on the account) of the requesting user. Moreover, the product distribution site 800 can include or access an e-commerce module 812 that can serve to initiate payment processing.

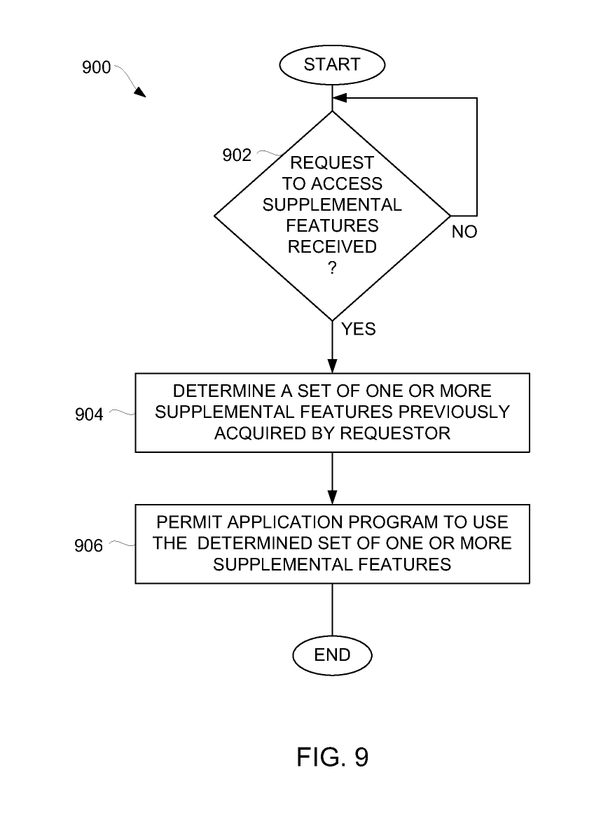

FIG. 9 is a flow diagram of a feature re-acquisition process 900 according to one embodiment. As an example, the feature re-acquisition process 900 can be performed at least in part by the re-acquisition manager 804 of the product distribution site 800 illustrated in FIG. 8.

The feature re-acquisition process 900 can begin with a decision 902 that determines whether a request to access supplemental features has been received. The request to access supplemental features, if received, can be received at the re-acquisition manager 804 from a client device associated with a requestor (user). In any case, when the decision 902 determines that a request to access supplemental features has not been received, the feature-acquisition process 900 can await such a request.

Alternatively, when the decision 902 determines that a request to access supplemental features has been received, a set of one or more supplemental features previously acquired by the requestor can be determined 904. These supplemental features were previously acquired for use with an application program. The feature re-acquisition process 900 can permit 906 the application program (which requestor presumably already has) to use the determined set of one or more supplemental features. In one usage scenario, the re-acquisition manager 804 can notify the application program already having the supplemental features (e.g., locked) that the requestor (user) is authorized to use the determined set of one or more supplemental features (e.g., supplemental features can be unlocked). In another usage scenario, the re-acquisition manager 804 can cause the product distribution site to facilitate download of the determined set of one or more supplemental feature to the client device where they can be used (including unlocked if needed) for use with the application program. Following the block 906, the feature re-acquisition process 900 can end.

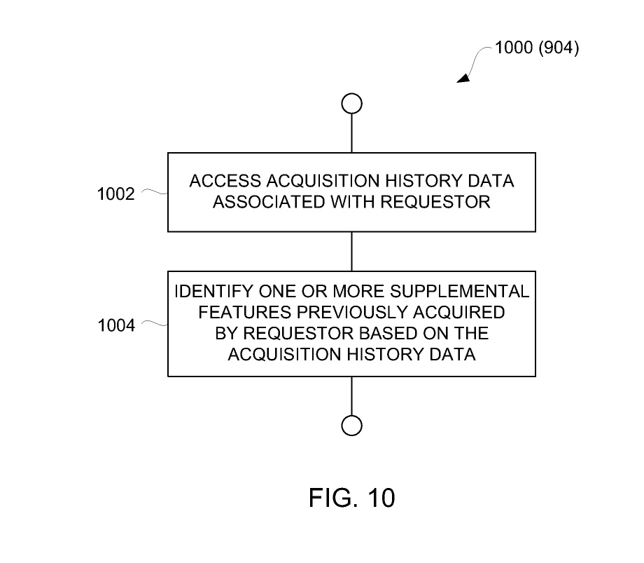

FIG. 10 is a flow diagram of previously acquired features process 1000 according to one embodiment. The previously acquired features process 1000 can, for example, be associated with processing performed by block 904 of the re-acquisition process 900 illustrated in FIG. 9, according to one embodiment.

The previously acquired features process 1000 can access 1002 acquisition history data associated with the requestor. For example, the acquisition history data can be stored in the purchase history 806 at the product distribution site 800, and access 1002 to the acquisition history data can cause the appropriate acquisition history data to be retrieved from the purchase history 806. In one embodiment, the purchase history 806 can store information regarding prior transactions for application programs as well as supplemental features by various requestors. After the acquisition history data for the requestor has been accessed 1002, one or more supplemental features previously acquired by the requestor can be identified 1004 based on the acquisition history data.

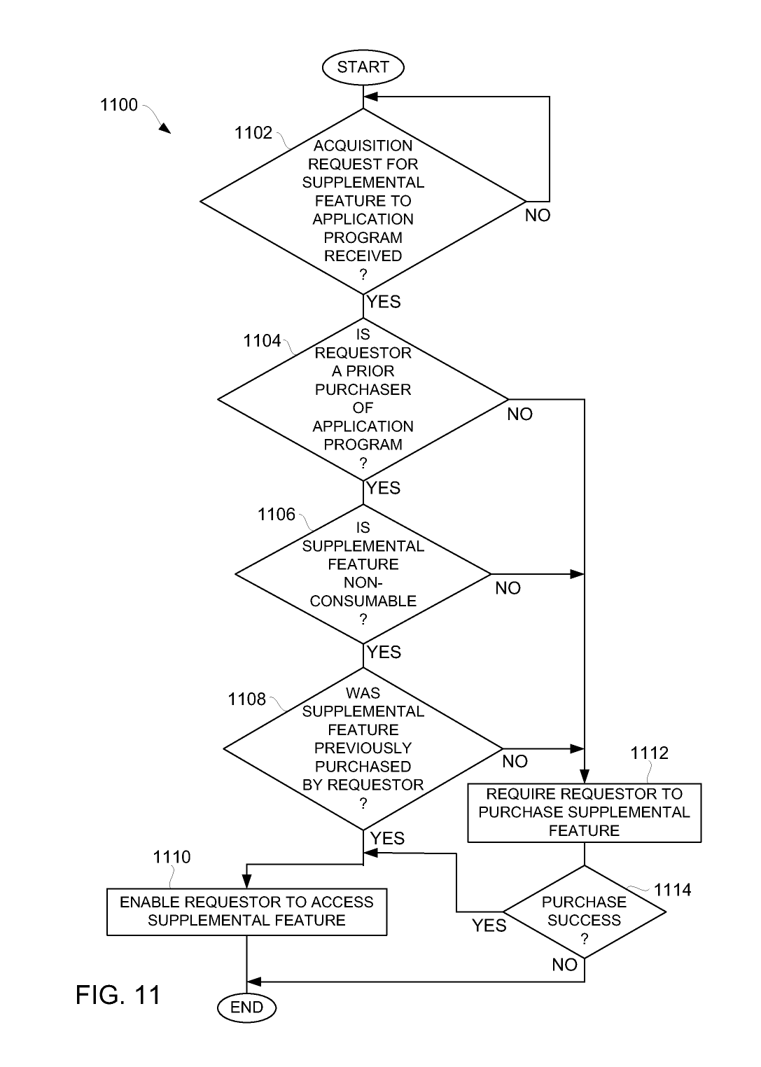

FIG. 11 is a flow diagram of a supplemental feature access process 1100 according to one embodiment. The supplemental feature access process 1100 can, for example, be performed at least in part by the re-acquisition manager 804 of the product distribution site 800 illustrated in FIG. 8.

The supplemental feature access process 1100 can begin with a decision 1102 that determines whether an acquisition request for a supplemental feature to an application program has been received. When the decision 1102 determines that an acquisition request for a supplemental feature has not been received, the supplemental feature access process 1100 can await such a request.

Alternatively, when the decision 1102 determines that an acquisition request for a supplemental feature has been received, a decision 1104 can determine whether the requestor of the acquisition request is a prior purchaser of an appropriate application program. The acquisition request is for a supplemental feature associated with a particular application program. At decision 1104, it is determined whether the requestor is a prior purchaser of the particular application program. In one implementation, purchase history data can be used to determine whether the requestor previously purchased the particular application program.

When the decision 1104 determines that the requestor is a prior purchaser of the particular application program, a decision 1106 can determine whether the supplemental feature being requested is a non-consumable feature. A non-consumable feature is a feature that is effectively reusable with respect to the application program, and it is not consumed immediately upon use. When the decision 1106 determines that the supplemental feature being requested is non-consumable, a decision 1108 can determine whether the supplemental feature being requested was previously purchased by the requestor. Here, for example, the purchase history data being archived at a product distribution site can be utilized in determining whether the supplemental feature being requested was previously purchased by the requestor.

When the decision 1108 determines that the supplemental feature being requested was previously purchased by the requester, the supplemental feature access process 1100 can enable 1110 the requestor to access the supplemental feature being requested. In this case, the acquisition request for the supplemental feature by the requestor is satisfied by enabling 1110 the requestor to access the supplemental feature. In one implementation, the requestor can access the supplemental feature by unlocking the supplemental feature already resident in the application program on the client device. In another implementation, the requestor can access the supplemental feature by downloading the supplemental feature to the client device for being used with the application program (and being unlocked if needed).

On the other hand, when the decision 1104 determines that the requestor is not a prior purchaser of the particular application program, or when the decision 1106 determines that the supplemental feature it is consumable, or when the decision 1108 determines that the supplemental feature being requested was not previously purchased by the requestor, then the supplemental feature access process 1100 operates to require 1112 the requestor to purchase the supplemental feature. A decision 1114 can then determine whether in the supplemental feature has been successfully purchased. When the decision 1114 determines that the purchase of the supplemental feature has been successful, then the supplemental feature access process 1100 can proceed to thereafter enable 1110 the requestor to access the supplemental feature. For example, the supplemental feature can be downloaded to the requestor or unlocked if already available to the application program. A receipt can also be provided to the requestor. The receipt is an electronic document, such as a markup language document (e.g., XML document), that can specify at least a digital product identifier (e.g., supplemental feature identifier), an application identifier, a transaction date, and a transaction identifier. If the receipt is for a re-delivery (or re-grant) of a prior purchase, the receipt can also include an original purchase identifier and an original purchase date. In some cases, such as for reoccurring content (e.g., subscriptions), the receipt can include an expiration date. The receipt can be cryptographically signed to preserve its integrity.

When the receipt is for a re-delivery or re-access for a supplemental feature previously purchased, the receipt can also include original transaction identifier and an original transaction date. The supplemental feature access process 1100 can end following block 1110 with the requestor gaining access to the supplemental feature. Alternatively, when the decision 1114 determines that the purchase of the supplement feature was not successful, the supplemental feature access process 1110 can end without the requestor gaining access to the supplemental feature.

Although the supplemental feature access process 1100 is discussed in FIG. 11 with reference to accessing a single supplemental feature, it should be understood that the supplemental feature access process 1100 can also be used to access a plurality of supplemental features. In one implementation, providing access to a single supplemental feature can be considered a re-download process. In another implementation, providing access to a plurality of supplemental features can be considered a re-grant process.

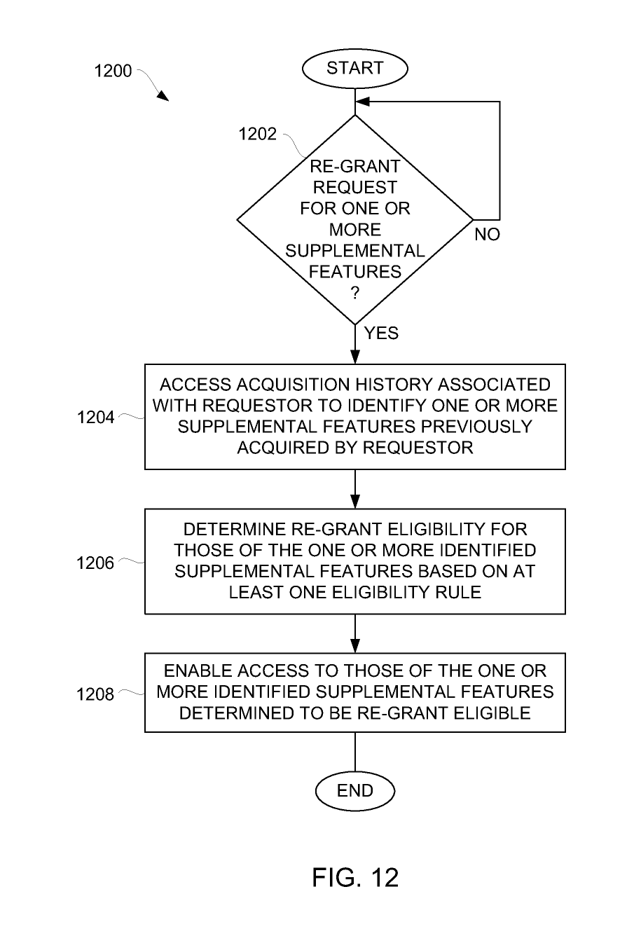

FIG. 12 is a re-grant process 1200 according to one embodiment. The re-grant process 1200 can, for example, be performed at least in part by the re-acquisition manager 804 of the product distribution site 800 illustrated in FIG. 8.

The re-grant process 1200 can begin with a decision 1202 that determines whether a re-grant request for one or more supplemental features has been received. When the decision 1202 determines that a re-grant request for one or more supplemental features has not been received, the re-grant process 1200 can await such a request. Once the decision 1202 determines that a re-grant request has been received, acquisition history associated with a requestor can be accessed 1204 to identify one or more supplemental features previously acquired by the requestor. Then, re-grant eligibility can be determined 1206 for those of the one or more identified supplemental features based on one or more eligibility rules. As noted above, the one or more eligibility rules can be provided by the eligibility rules 810 of the product distribution site 800 illustrated in FIG. 8. Thereafter, access can be enabled 1208 to those of the one or more identified supplemental features that have been determined to be re-grant eligible. Following the block 1208, the re-grant process 1200 can end.

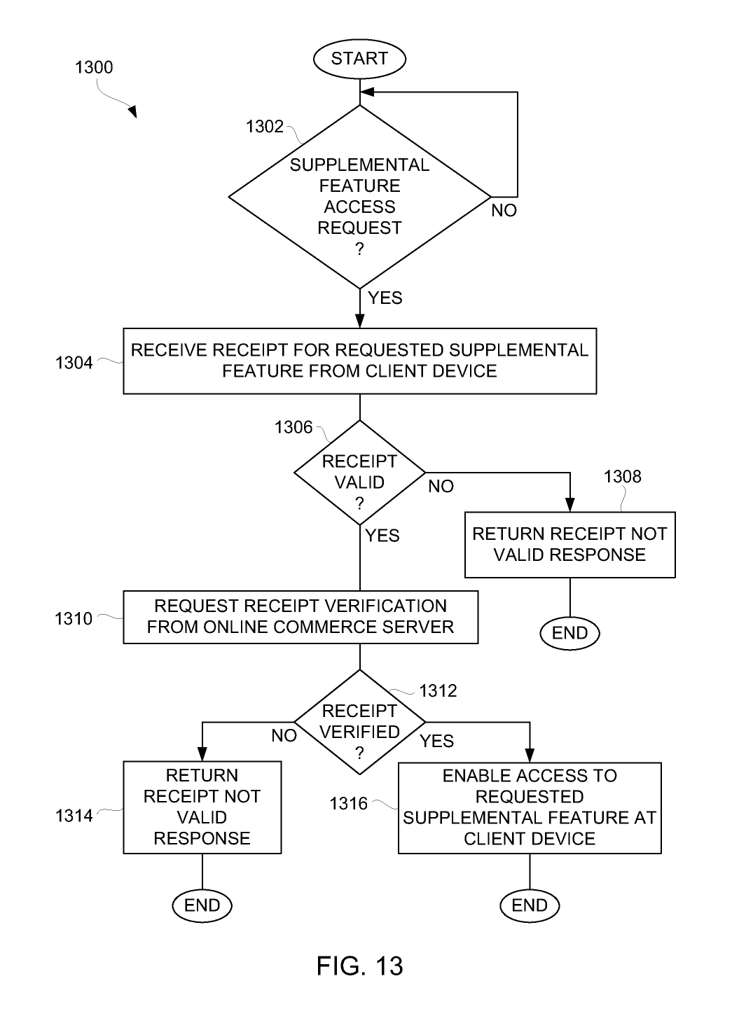

FIG. 13 illustrates a flow diagram of a supplemental feature access process 1300 according to one embodiment. The supplemental feature access process 1300 can be performed by server computer. For example, the supplemental feature access process 1300 can be performed by a developer server associated with the application program supporting the supplemental features. The developer server can, for example, couple to the data network 100 illustrated in FIG. 1.

The supplemental feature access process 1300 can begin with a decision 1302 that determines whether a supplemental feature access request has been received. When the decision 1302 determines that a supplemental feature access request has not been received, the supplemental feature access process 1300 awaits such a request. In other words, the supplemental feature access process 1300 can effectively be invoked when a supplemental feature access request has been received. Typically, the supplemental feature access request will be received from a client device performing processing such as in block 508 of the supplemental feature client process 500 illustrated in FIG. 5.

Once the decision 1302 determines that a supplemental feature access request has been received, the supplemental feature access process 1300 can perform processing in response to the supplemental feature access request. In particular, a receipt for the requested supplemental feature can be received 1304 from the client device. The receipt can be part of the supplemental feature access request or can be separately provided.

Next, a decision 1306 can determine whether the receipt that has been received is valid. The validation of the receipt can involve a digital signature check. When the decision 1306 determines that the receipt is not valid, a receipt not valid response can be returned 1308 to the client device. Following the block 1308, the supplemental feature access process 1300 can end since the subscriber has not tendered a valid receipt and thus is not permitted to access supplemental feature.

On the other hand, when the decision 1306 determines that the receipt is valid, receipt verification can be requested 1310 from an online commerce server. The online commerce server is, for example, the product distribution site 102 illustrated in FIG. 1. Next, a decision 1312 can determine whether the receipt has been verified by the online commerce server. Here, the server computer (e.g., developer server) performing the supplemental feature access process 1300 can receive from the online commerce server an indication whether the receipt has been verified. When the decision 1312 determines that the receipt has not been verified, a receipt not valid response can be returned 1314 to the client device. Here, although the client device had a valid receipt (e.g., not expired), the online commerce server has informed the server computer that the receipt is not able to be verified (i.e., invalid) for the supplemental feature being requested. In other words, the receipt is bad and the client device is thus not entitled to receive the supplemental feature being requested. The receipt can be considered valid for any of a number of reasons. As one example, the receipt can be invalidated prior to its expiration if the requestor has been canceled (or purchase money refunded) the transaction for access to the supplemental feature since the receipt was produced. As another example, the receipt can be invalidated if deemed fraudulent. Following the block 1314, the supplemental feature access process 1300 can end since they subscriber has been determined not eligible to receive the requested supplemental feature.

Alternatively, when the decision 1312 determines that the receipt has been verified, access to the requested supplemental feature at the client device can be enabled 1316. Once the access to the requested supplemental feature has been enabled 1316, the client device can access the requested supplemental feature in any of a variety of different ways depending upon implementation. For example, the client device could have the requested supplemental feature “unlocked” in cases where the supplemental feature is previously stored on the client device in a “locked” condition. As another example, the client device could download the requested supplemental feature from the server computer. The download could occur immediately following block 1316 or could be deferred until a more suitable time. Following the block 1316, the supplemental feature access process 1300 can end.

In another embodiment, the server computer can itself verify a renewal receipt without having to request receipt verification from the online commerce server over a network connection. Advantageously, the server computer is able to verify a receipt faster and with less loading imposed on the online commerce server.

Additionally, the acquisition or re-acquisition as described herein can also be applicable to subscriptions for digital products including digital content. A subscription for a digital product can provide digital content to subscribers for a period of time. In one embodiment, a subscription for a digital product can be purchased from an online store, and then a subscriber can receive digital content associated with the subscription. The subscription may require renewal if the subscription is to be continued. A subscription server can be provided to manage renewal of subscriptions, including payment of subscription renewal fees, so that subscriptions can be renewed and thus continued. Receipts for payments can be electronically distributed so that, upon renewal, digital content providers for subscriptions can verify that a given subscriber has renewed a particular subscription for a digital product. The digital products provided as a subscription can be any type of digital data. For example, the digital data can be digital media assets (audio, graphic, video, etc.), games (or game levels or features), application programs (or program features), or periodicals (newspapers, magazines), articles, reports, presentations, shows, or blogs. Additional information on subscription and renewals thereof is provided in U.S. patent application Ser. No. 12/694,206, filed Jan. 26, 2010, entitled “SUBSCRIPTION RENEWALS FOR DIGITAL CONTENT”, is hereby incorporated herein by reference.

According to another aspect, a client device can have a download interface that facilitates application programs operating on a client device to request and receive downloads from a remote data repository. A user of a client device may have previously acquired rights or permissions to access one or more supplemental content for use by one or more application programs. Typically, a user would purchase an application program and then sometime later, using the application program, also purchase supplemental content for use with the application program. In one implementation the supplemental content can be purchased using the application program itself. Once the supplemental content is purchased, it needs to be downloaded to the client device. Download policies are used to manage the download of supplemental content.

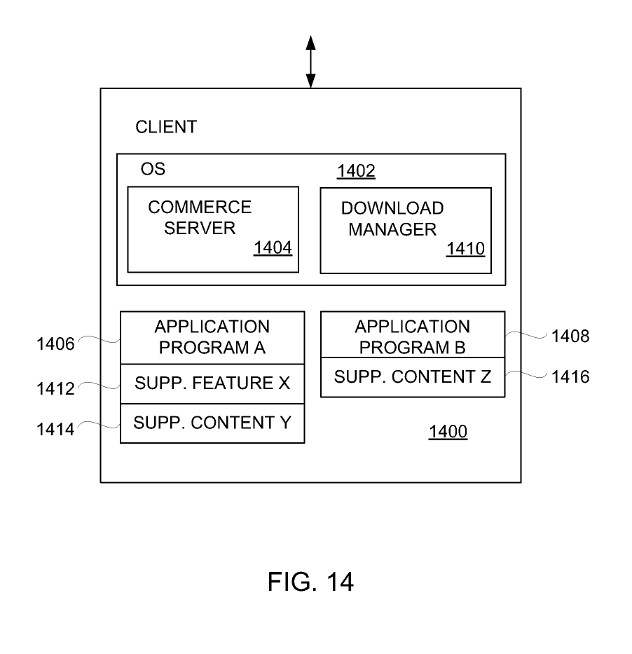

FIG. 14 is a block diagram of a client 1400, or client device, according to another embodiment. The client 1400 can, for example, be suitable for use as the client 110 illustrated in FIG. 1.

The client 1400 includes an operating system (OS) 1402 that operates on the client 1400 to provide basic computing services to application programs that may execute on the client 1400. In addition, the operating system 1402 includes a commerce server 1404. The commerce server 1404 is utilized by application programs operating on the client 1400 to perform commerce operations with respect to a remote server, such as a remote digital product distribution server. For example, the remote server can pertain to the product distribution server 102 illustrated in FIG. 1.

The client 1400 can also includes one or more application programs that are installed on the client 1400 and which can be executed by the client 1400. Typically, these application where acquired and download from a remote server (e.g., product distribution server 102) to the client 1400. The applications resident and installed on the client 1400 are represented by application program A 1406 and application program B 1408. The operating system 1402 can also include a download manager 1410 to manage downloads for the application programs 1404 and 1408.

As illustrated in FIG. 14, the application program A 1406 includes a supplemental feature X 1412 and supplemental content Y 1414. Typically, as the application program A 1406 is initially acquired from a remote server, the supplemental feature X 1412 can be present but “locked” and thus are not currently usable. The application program A 1406 can interact with the remote server (e.g., remote digital product distribution server) by way of the commerce server 1404 so as to have the supplemental feature 1410 “unlocked”. Once a supplemental feature becomes “unlocked”, the associated application program can thereafter utilize the supplemental feature.

Sometime after the application program A 1406 has been acquired, the remote server may have supplemental content for the application program A 1406. Similarly, sometime after the application program B 1408 has been acquired, the remote server may have supplemental content for the application program B 1408. Typically, the supplemental content is digital data that can be used by an application program. Often the supplemental content is presentable by the application program for the user of the client 1400. The download manager 1410 serves to manage the download of supplemental content for application programs. The download manager 1410 can manage download of supplemental content for one or more application programs. The download manager 1410 can use one or more download policies to manage the downloads for the one or more applications. Through use of the download manager 1410, the supplemental content Y 1414 is obtained for use by the application program A 1406, and the supplemental content Z 1416 is obtained for use by the application program B 1408.

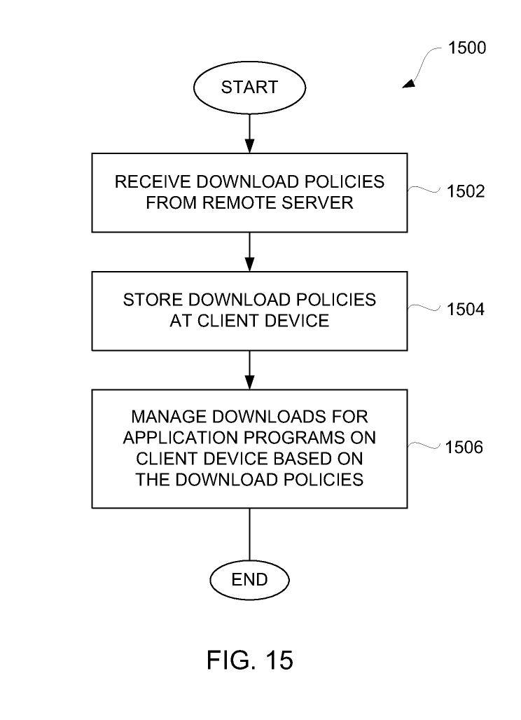

FIG. 15 is a flow diagram of a download management process 1500 according to one embodiment. The download management process 1500 is, for example, performed by a client device, such as the client 110 (client device) illustrated in FIG. 1.

The download management process 1500 can receive 1502 one or more download policies from a remote server. The remote server controls access and distribution of numerous digital assets, including supplemental content for use with applications. The remote server can, for example, be the product distribution site 102 illustrated in FIG. 1, which can be implemented by one or more server computers. The remote server can also be referred to as a cloud server.

Here, the client device can request the one or more download policies from the remote server at predetermined times. In one implementation, the download management process 1500 is associated with an application program operating on the client device. On invoking the application program, the download policies can be obtained at the client device from the remote server. Alternatively, the client device could periodically confirm that it has the most current download policies. Still further yet, in another embodiment, the remote server could notify the client device when revised download policies are available.

In any case, after the one or more download policies have been received 1502 from the remote server, the one or more download policies can be stored 1504 at the client device. The download policies can be stored in volatile or nonvolatile manner at the client device. Once the client device has the one or more download policies, the client device can manage 1506 downloads for one or more application programs operating on the client device based on the one or more download policies. The downloads can pertain to download of supplemental content for the one or more application programs. In one embodiment, the supplemental content is purchased via the one or more application programs and then approved for download. Following the management 1506 of the downloads, the download management process 1500 can end.

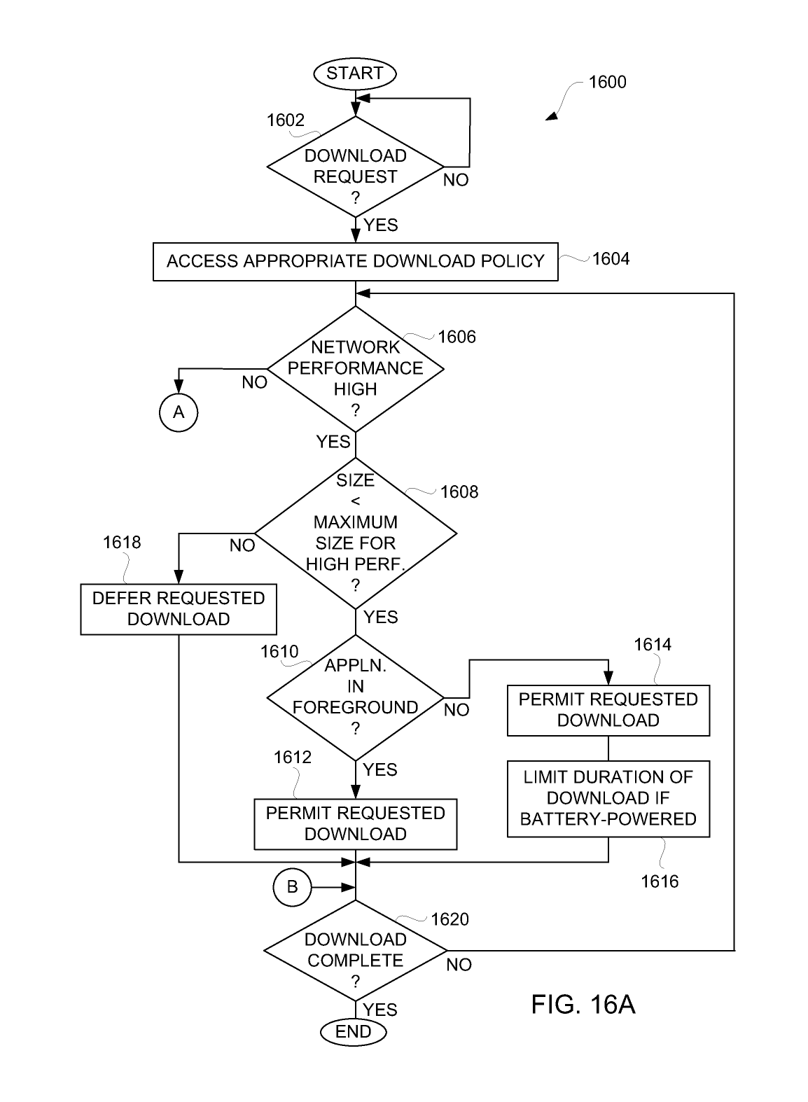

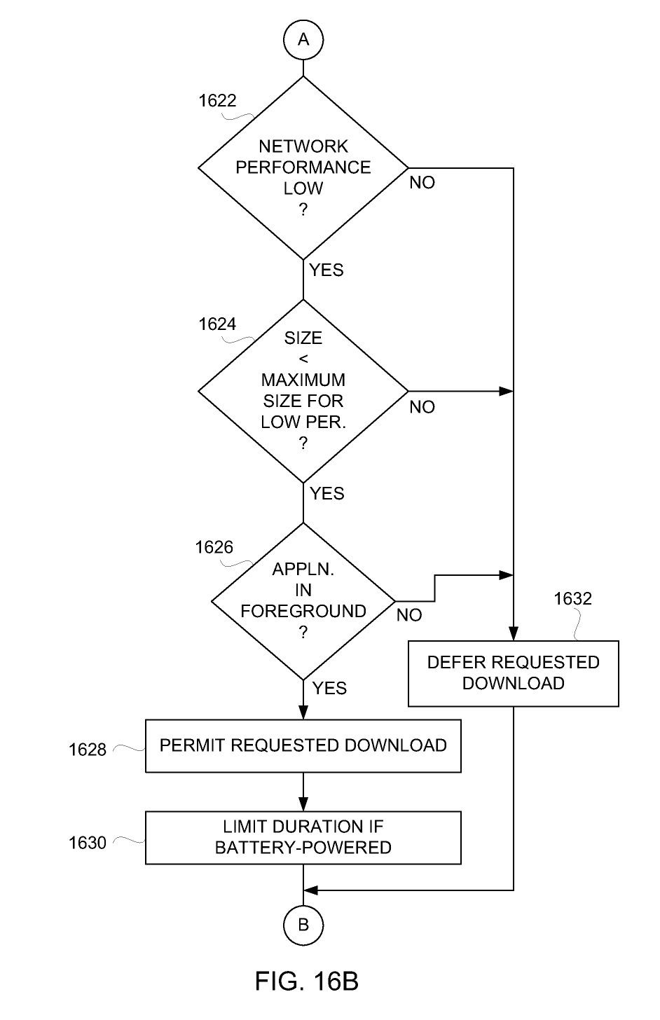

FIGS. 16A and 16B illustrate a download management process 1600 according to another embodiment. The download management process 1600 can be performed by a client device, such as the client 110 (client device) illustrated in FIG. 1.

The download management process 1600 can begin with a decision 1602 that determines whether a download request has been received. For example, an application program operating on the client device can be operating and a user of the client device may interact with the application to request a download. For example, the request to download can request to download content, such as supplemental content, that can be utilized by the application program. When the decision 1602 determines that the download request has not yet been received, the download management process 1600 can await such a request.

Once the decision. 1602 determines that a download request has been received, an appropriate download policy can be accessed 1604. Here, the client device currently stores or obtains the appropriate download policy. The download policy can vary dependent upon on or more of various criteria, such as type of digital asset (content) being requested, type of device being utilized as the client device, user preferences, size of digital asset (content) to be downloaded, power source, network performance, etc.

The download management process 1600 can perform a decision 1606 that determines whether network performance is high. For example, network performance is performance of the network coupled between the client device and the remote server. The network performance is high if the network is a high-speed network. As a specific example, if the client device is coupled (wired or wirelessly) to a local area network (e.g., Wi-Fi), then the network performance is deemed high. On the other hand, if the client device is coupled to the remote server by way of a cellular link, the network performance is low and thus not deemed high performance.

In any event, when the decision 1606 determines that the network performance is high, a decision 1608 can determine whether the size of the content being requested for download is less than a maximum size for high performance downloads. When the decision 1608 determines that the size of the requested content is less than the maximum size for high performance downloads, a decision 1610 can determine whether the application operating on the client device is presently operating in the foreground. When the decision 1610 determines that the application is operating in the foreground, the requested download is permitted. 1612. Hence, the requested download can be performed so that the content requested by the download request can be received at the client device.

Alternatively, when the decision 1610 determines that the application is not operating the foreground (i.e., operating in the background), the requested download can also be permitted 1614. However, in this situation, the duration of the download can be limited 1616 if the client device is being battery-powered. By limiting the duration of download, the download policy presents excessive battery drain due to downloads. In should be noted that whether the application is operating in the foreground or the background can be referred to as its application operating state.

Still further, if the decision 1608 determines that the size of the requested content for download is not less than the maximum size for high-performance downloads, the requested download can be deferred 1618 because the requested content is too large to permit download. Here, the requested content could later be provided to the client device when connected to a high speed wireless network, such as when coupled to a host computer that has a wired link to the Internet.

Following the block 1612, 1616 and 1618, a decision 1620 can determine whether the download has been completed. When the decision 1620 determines that the requested download has not completed, the download management process 1600 can return to repeat the decision 1606 so that the download can not only continue but also so that conditions influencing the download can be updated, such as network performance and foreground/background operation. Alternatively, when the decision 1620 determines that the download has completed, the download management process 1600 can end.

Additionally, with respect to the decision 1606, when it is determined that the network performance is not high, then the ability to download is decreased as compared to a high-performance network. Hence, the likelihood is then that the download operations are less robust.

A decision 1622 determines whether the network performance is low. When the decision 1622 determines that network performance is low, a decision. 1624 determines whether the size of the requested content is less than the maximum size for low performance downloads. When the size of the requested content is less than the maximum size for the lower performance download, a decision 1626 determines whether the application is in the foreground. When the decision 1626 determines that the application is in the foreground, the requested download can be permitted 1628. Here, the requested download is permitted 1628 because, although the network performance low, the size of the requested content is less than the maximum size and the application making a request for the content is operating in the foreground. In addition, when the requested download is permitted. 1628, the duration for the download can be limited 1630, particularly if the client device is being battery-powered.

Still further, in the event that (i) the decision 1626 determines that the application is not operating the foreground (i.e., operating in the background), (ii) the decision 1624 determines that the size of the requested content is not less than the maximum size, or (iii) the decision 1622 determines that the network performance not low (in this case, meaning that the network performance is too low or that there is essentially no network connection available), the requested download can be deferred 1632. In other words, the requested download would not be performed due to the conditions being evaluated. Following the block 1630 or the block 1632, the download management process 1600 returns to the decision 1620 which determines whether or not the download has completed.

According to another aspect, third-party content can be submitted to and distributed by a content distribution system. In other words, the third-party content can be hosted (and distributed) by the content distribution system. The content distribution system can allow application programs to be supplemented by supplemental content that is associated with a previously obtained (e.g., purchased) application program.

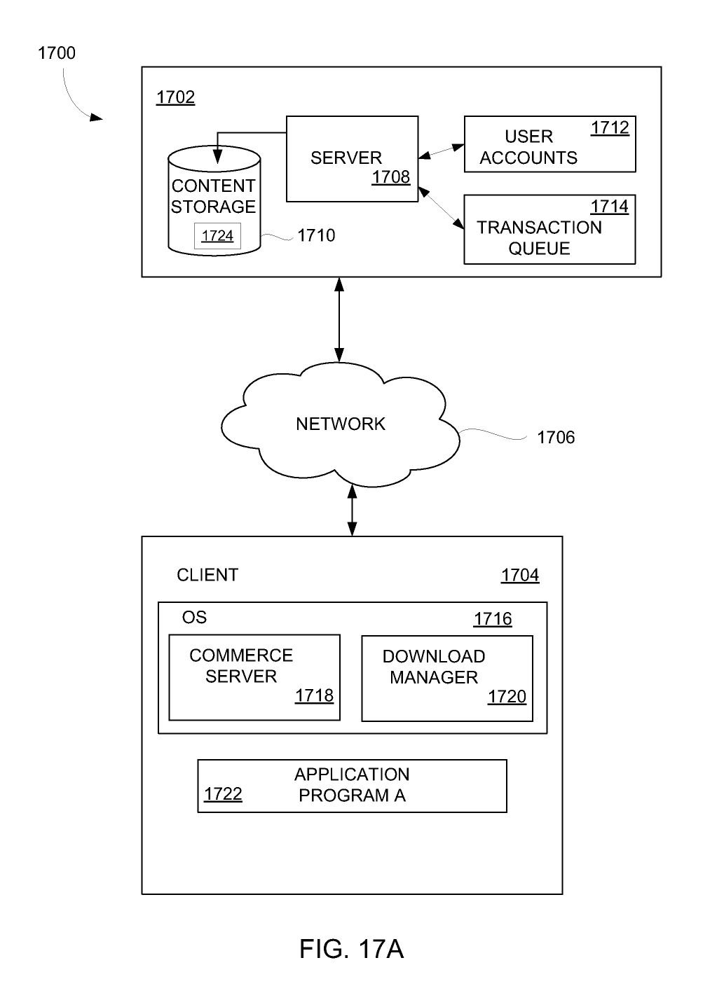

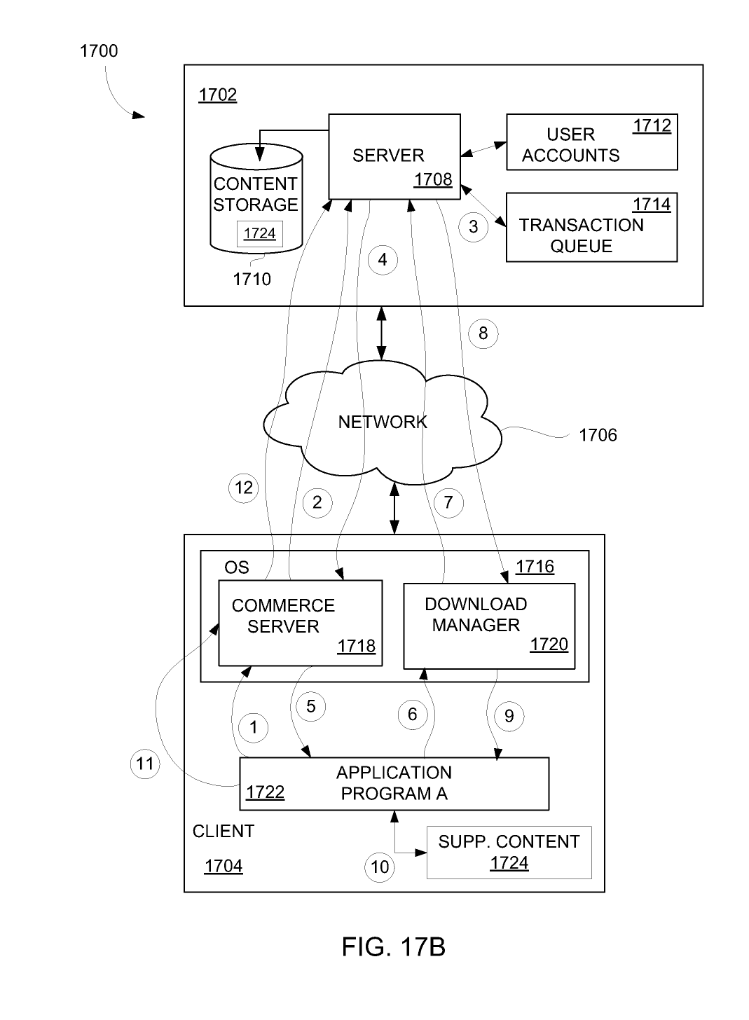

FIG. 17A is a block diagram of a network-based content distribution system 1700 according to one embodiment. The network-based content distribution system 1700 includes a content distribution server system 1702, which supports a plurality of client devices 1704 by way of communications through a data network 1706. The content distribution server system 1702 includes a server 1708 for controlling overall operation of the content distribution server system 1702. The server 1708 couples to a content storage 1710. The content storage. 1710 can store various digital assets that are able to be distributed electronically by the content distribution server system 1702. The digital assets stored in the content storage 1710 can, for example, include application programs as well as supplemental content for application programs. In addition, the server 1708 can couple to user accounts which stores account information on users having accounts. The server 1708 can also couple to a transaction queue 1714. The transaction queue 1714 stores transaction information for acquisitions (purchases) of certain of the digital assets stored in the content storage 1710.

The client device 1704 illustrated in FIG. 17A represents an exemplary client device suitable for interacting with the content distribution server system 1702 by way of the data network 1706. The client device 1704 includes an operating system. 1706, which controls the overall operation of the client device, typically via the execution of a processor. The operating system 1716 for supporting content distribution further includes a commerce server 1718 and a download manager 1720. The commerce server 1718 provides programming resources that facilitate the client device 1704 interacting with the content distribution server system 1702 to perform a commerce transaction, such as purchasing an application program or supplemental content. The download manager 1720 is used by the client device. 1704 to download digital assets that have been acquired from the content distribution server system 1702. In this regard, the download manager 1720 can operate to manage one or more downloads to the client device 1704 in accordance with download policies. At least a portion of the download policies can be provided to the client device 1704 from the content distribution server system 1702. The download manager 1720 provides the client device 1704 with the ability to control download, namely, to start, stop and pause download depending upon various conditions known to the client device 1704. Hence, among other things, the download manager 1720 can download to the client device 1704 an application program or supplemental content that has been acquired (e.g., purchased) from the content distribution server system 1702. The client device 1704 also includes an application program 1722. Typically, however, the client device 1704 would store a plurality of distinct application programs. Hence, the application program 1722 can be considered a representative program. If the client device 1704 has acquired (purchased) supplemental content 1724 from the content distribution server system 1702 using the commerce server 1718, the download manager 1720 can then operate to manage the download of the supplemental content 1724 from the content distribution server system 1702 to the client device. 1704.

FIG. 17B is a block diagram of the network-based content distribution system 1700 shown in FIG. 17A when supplemental content acquired and downloaded.

Initially, the application program 1722 issues an acquisition request to the commerce server 1718 (step 1). The acquisition request is a request to acquire, through purchase or otherwise, supplemental content to be utilized by the application program 1722. The commerce server 1718 then issues a content request with appropriate credentials to the server 1708 of the content distribution server system 1702 (step 2). The server 1708 then processes the content request, and in so doing inserts transaction information into the transaction queue 1714 (step 3). The processing of the content request may also utilize account information 1712 associated with the user of the client device 1704. Subsequently, the server 1708 informs the commerce server 1718 that the content request has been processed and the appropriate transaction information, including a receipt corresponding to the acquisition, is provided in the transaction queue 1714 (step 4).

The commerce server 1718 can then access the transaction information from the transaction queue 1714 and provide a transaction response to the application program 1722 (step 5). The transaction response can identify the acquired supplemental content that is permitted, as a result of the transaction, to be downloaded to the client device 1704.

After receiving the transaction response, the application program 1722 can issue a download request to the download manager 1720 for the acquired supplemental content (step 6). The download manager 1720 can then issue a download request to the server 1708 (step 7). In response to the download request, the server 1708 can access the content storage 1710 to retrieve the supplemental content 1724, which can then be provided to the download manager 1720 (step 8). At the download manager 1720, the received supplemental content from the downloading can be processed, such as decrypting and decompressing, and then stored at a predetermined location in the client device 1704. The download manager 1720 can then send a response to the application program 1722 to alert the application program 1722 that the supplemental content is stored at the client device at the predetermined location (step 9). At this point, the supplemental content 1724, which was acquired from the content distribution server system 1702, is stored at the client device 1704 and is associated with the application program 1722 such that the application program 1722 can make use of the supplemental content 1724 (step 10). The application program 1722 can then inform the commerce server 1718 that the transaction has been completed and the supplemental content 1724 has been successfully received (step 11). The commerce server 1718 can then inform the server 1708 that the transaction has completed and that the transaction information can be removed from the transaction queue 1714 (step 12).

The download operations discussed herein in FIGS. 17A and 17B can immediately follow acquisition (e.g., purchase) of content, or can be deferred to a later point in time. As discussed above herein, the downloading of digital content can be performed at different points in time and in different manners depending upon various criteria, such as network performance, content size, power source, application state, and the like.

U.S. Provisional Patent Application No. 61/160,640, filed Mar. 16, 2009, entitled “APPLICATION PRODUCTS WITH IN-APPLICATION SUBSEQUENT FEATURE ACCESS USING NETWORK-BASED DISTRIBUTION SYSTEM”, is hereby incorporated herein by reference.

This application also references and/or incorporates: (1) U.S. patent application Ser. No. 10/687,534, filed Oct. 15, 2003, and entitled “METHOD AND SYSTEM FOR SUBMITTING MEDIA FOR NETWORK-BASED PURCHASE AND DISTRIBUTION”, which is hereby incorporated herein by reference; (2) U.S. patent application Ser. No. 11/712,303, filed Feb. 27, 2007, and entitled “PROCESSING OF METADATA CONTENT AND MEDIA CONTENT RECEIVED BY A MEDIA DISTRIBUTION SYSTEM”, which is hereby incorporated herein by reference; (3) U.S. patent application Ser. No. 11/609,815, filed Dec. 12, 2006, and entitled “TECHNIQUES AND SYSTEMS FOR ELECTRONIC SUBMISSION OF MEDIA FOR NETWORK-BASED DISTRIBUTION”, which is hereby incorporated herein by reference; (4) U.S. patent application Ser. No. 11/622,923, filed Jan. 12, 2007, and entitled “COMPUTERIZED MANAGEMENT OF MEDIA DISTRIBUTION AGREEMENTS” , which is hereby incorporated herein by reference; (5) U.S. patent application Ser. No. 12/286,076, filed Sep. 26, 2008, entitled “ELECTRONIC SUBMISSION AND MANAGEMENT OF DIGITAL PRODUCTS FOR NETWORK-BASED DISTRIBUTION”, which is hereby incorporated herein by reference; (6) U.S. patent application Ser. No. 12/286,075, filed Sep. 26, 2008, entitled “NETWORK-BASED DISTRIBUTION OF APPLICATION PRODUCTS”, which is hereby incorporated herein by reference; (7) U.S. patent application Ser. No. 12/286,092, filed Sep. 26, 2008, entitled “ELECTRONIC SUBMISSION OF APPLICATION PROGRAMS FOR NETWORK-BASED DISTRIBUTION”, which is hereby incorporated herein by reference; (8) U.S. patent application Ser. No. 12/368,111, filed Feb. 2, 2009, entitled “INTELLIGENT DOWNLOAD OF APPLICATION PROGRAMS”, which is hereby incorporated herein by reference; (9) U.S. Provisional Patent Application No. 61/180,925, filed May 25, 2009, entitled “CONFIGURATION AND MANAGEMENT OF ADD-ONS TO DIGITAL APPLICATION PROGRAMS FOR NETWORK-BASED DISTRIBUTION”, which is hereby incorporated herein by reference; and (10) U.S. patent application Ser. No. 12/571,260, filed Sep. 30, 2009, entitled “CONFIGURATION AND MANAGEMENT OF ADD-ONS TO DIGITAL APPLICATION PROGRAMS FOR NETWORK-BASED DISTRIBUTION”, which is hereby incorporated herein by reference.

The various aspects, features, embodiments or implementations of the invention described above can be used alone or in various combinations.

Embodiments of the invention can, for example, be implemented by software, hardware, or a combination of hardware and software. Embodiments of the invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

Numerous specific details are set forth in order to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

In the foregoing description, reference to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer-implemented method for managing download of electronic content to client devices, the method comprising:
receiving at least one download policy from a remote server to a local client device via at least one network;
storing the at least one download policy at the local client device; and
managing downloads for at least one application program operable on the client device based on the at least one download policy.

2. A computer-implemented method as recited in claim 1, wherein the download policy is dependent on each of (i) network performance available to the local client device, (ii) source of electrical power, (iii) application operating state, and (iv) size of requested download.

3. A computer-implemented method as recited in claim 1, wherein the download policy is dependent on two or more of (i) network performance available to the local client device, (ii) source of electrical power, (iii) application operating in background, and (iv) size of requested download.

4. A computer-implemented method as recited in claim 1, wherein the download policy is dependent on network performance available to the local client device, and is dependent on application operating state.

5. A computer-implemented method as recited in claim 1, wherein the downloads being managed comprise at least one download of supplemental content to be downloaded and made available to the at least one application program operating on the client device.

6. A computer-implemented method as recited in claim 1, wherein the managing of the download for the at least one client device comprises:
receiving a download request for electronic content from an application operating on the local client device;
determining whether the application is operating in a foreground or background;
permitting download of the requested download provided that it is determined that the application is operating in the foreground; and
deferring download of the requested download provided that it is determined that the application is operating in the background.

7. A computer-implemented method as recited in claim 1, wherein the managing of the download for the at least one client device comprises:
determining whether the local client device is under battery power; and
limiting the permitted download of the requested download while the local client device is under battery power.

8. A computer-implemented method as recited in claim 7, wherein the limiting of the permitted download of the requested download while the local client device is under battery power comprises:
limiting duration of the download of the requested download while the local client device is under battery power.

9. A computer-implemented method as recited in claim 1, wherein the managing of the download for the at least one client device comprises:
receiving a download request for electronic content from an application operating on the local client device;
determining network performance for the at least one network that is available to the local client device; and
managing the download of the electronic content based on the at least one download policy and on the determined network performance.

10. A computer-implemented method as recited in claim 1, wherein the at least one download policy comprises a maximum download size, and wherein the managing of the download for the at least one client device comprises:
receiving a download request for electronic content from an application operating on the local client device, the electronic content to be downloaded having a download size;
determining whether the download size is greater than the maximum download size; and
preventing the download of the electronic content when it is determined that the download size is greater than the maximum download size.

11. A non-transitory computer readable medium including at least computer program code for managing download of electronic content to client devices, the computer readable medium comprising:
computer program code for receiving at least one download policy from a remote server to a local client device via at least one network;
computer program code for storing the at least one download policy at the local client device; and
computer program code for managing downloads for at least one application program operable on the client device based on the at least one download policy.

12. A mobile computing device, comprising:
at least one application program able to operate in the mobile computing device;
a commerce server resident on the mobile computing device, the commerce server configured to interact with a remote server to facilitate access to supplemental content for use with the at least one application program; and
a download manager resident on the mobile computing device, the download manager configured to manage download of the supplemental content over a network to the mobile computing device, provided that the remote server permits access to the supplemental content.

13. A mobile computing device as recited in claim 12, wherein the mobile computing device is a handheld, multi-function electronic device.

14. A mobile computing device as recited in claim 13, wherein the handheld, multi-function electronic device provides capabilities for executing at least the at least one application program and for supporting wireless voice and data communications.

15. A mobile computing device as recited in claim 12, wherein the mobile computing device further comprises an operating system, and wherein the commerce server and the download manager are part of the operating system.

16. A portable client computing device, comprising:
an operating system including a commerce server and a download manager, the commerce server configured to communicate over a network with a remote server to acquire or activate application programs and supplemental features therefore, the download manager configured to manage download of at least the supplemental features; and
a data storage device configured to store an application program and also storing at least one supplemental feature for use by the application program,
wherein the application program to configured to communicate with the commerce server to: (i) acquire rights to access the at least one supplemental feature, and (ii) render the at least one supplemental feature accessible by the application program if the rights to acquire the at least one supplemental feature have been acquired, and
wherein the application program is configured to communicate with the download manager to receive the at least one supplemental feature and thereafter access the at least one supplemental feature.

17. A portable client computing device as recited in claim 16, wherein the at least one supplemental feature comprises supplemental content.

18. A portable client computing device as recited in claim 16, wherein the download manager operates in accordance with at least one download policy.

19. A portable client computing device as recited in claim 18, wherein the portable client computing device communicates with a remote network-based distribution system to obtain the at least one supplemental feature, and wherein the at least one download policy is provided to the portable client computing device via the remote network-based distribution system.

20. A method for accessing supplemental features of an application program, said method operating on a computing device, and said method comprising:
executing an application program on the computing device, the application program being previously acquired from a remote network-based distribution system;
determining, at the computing device, that a user of the application program desires to acquire usage of at least one supplemental feature that is available from the remote network-based distribution system;
requesting that the remote network-based distribution system approve access to the at least one supplemental feature;
receiving download information from the remote network-based application distribution system that the at least one supplemental feature is approved for access; and
thereafter downloading the at least one supplemental feature to the computing device, thereby permitting the application program to utilize the at least one supplemental feature.

21. A method as recited in claim 20, wherein the at least one supplemental feature comprises supplemental content.

22. A method as recited in claim 21, wherein the remote network-based distribution system stores and controls distribution of not only application programs but also supplemental content for a plurality of applications provided by various different content providers.

23. A method as recited in claim 20, wherein said requesting comprises:
sending a request to the remote network-based distribution system, the request including at least (i) a feature identifier for the at least one supplemental feature and (ii) an application identifier for the application program.

24. A method as recited in claim 20, wherein said requesting comprises:
sending a purchase request to the remote network-based distribution system for requesting purchase of the at least one supplemental feature.

25. A method as recited in claim 20, wherein the computing device is a handheld electronic device capable of at least executing the application program.

26. A method as recited in claim 20, wherein the computing device includes an operating system, and wherein communications between the application program and the remote network-based distribution system are handled through the operating system.
